(19) United States
(12) Patent Application Publication
(10) Pub. No.: US 2013/0080070 A1
(43) Pub. Date: Mar. 28, 2013

(54) CHEMOMETRICS FOR NEAR INFRARED SPECTRAL ANALYSIS

(71) Applicant: Dow AgroSciences LLC, Indianapolis, IN (US)

(72) Inventors: Reetal Pai, Carmel, IN (US); Daniel Z. Caraviello, Indianapolis, IN (US); Chuck Kahl, Westfield, IN (US); Daniel Garcia, Indianapolis, IN (US)

(73) Assignee: DOW AGROSCIENCES LLC, Indianapolis, IN (US)

(21) Appl. No.: 13/624,614

(22) Filed: Sep. 21, 2012

Related U.S. Application Data
(60) Provisional application No. 61/538,662, filed on Sep. 23, 2011.

(51) Int. Cl. G01N 21/25; G06F 19/00

(52) U.S. Cl. 702/19

(57) ABSTRACT

This disclosure concerns systems and methods for identifying and selecting a more accurate chemometric model for the analysis of specific plant samples via near infrared spectrometry. This disclosure further concerns the use of such systems and methods to identify characteristics and traits of interest in plants and plant samples, for example, to facilitate selective breeding, quality control, and/or inventory control.

### CROSS-REFERENCE TO RELATED APPLICATION

This application claims the benefit of U.S. Provisional Patent Application Ser. No. 61/538,662, filed Sep. 23, 2011, the disclosure of which is hereby incorporated herein in its entirety by this reference.

### FIELD OF THE DISCLOSURE

The present disclosure relates to systems and methods for analyzing near infrared spectral data corresponding to plant traits and characteristics. Aspects of the disclosure relate to methods for developing and identifying a chemometric analysis that is particularly well-suited for discerning a plat trait of interest from near infrared spectral data. Some aspects of the disclosure relate to the use of global, automated systems and methods, for example and without limitation, to select a plant comprising a trait or characteristic of interest from near infrared spectral data obtained from a plurality of plants.

### BACKGROUND

Near infrared spectroscopy (NIRS) employs photon energy to collect information from chemical or biological samples in the energy range of about 650 to 2500 nm (Bokobza (2002) “Origin of near infrared absorption bands,” In: Near-Infrared Spectroscopy: Principles, Instruments, Applications, Siesler et al., Eds., Weinheim, Germany: Wiley-VCH Verlag GmbH; Pasquini (2003) J. Brazilian Chem. Soc. 14:198-219). NIRS data from biological samples are acquired in the form of transmission or reflectance counts that are determined by stretching and bending vibrations of O-H, C-H, N-H and S-H chemical bonds in the sample. Miller (2001) “Chemical principles of near infrared technology,” In: Near Infrared Technology in the Agricultural and Food Industries, Norris and Williams, Eds., St. Paul, Minn., U.S.A.: American Association of Cereal Chemists, Inc.; Siesler (2002) “Introduction,” In: Near Infrared Spectroscopy: Principles, Instruments, Applications, supra.

In NIRS, a sample to be measured is irradiated with near infrared (NIR) radiation. While the NIR radiation penetrates the sample, the spectral characteristics of the incoming light change due to wavelength-dependent scattering and absorption processes that are determined by the chemical composition of the sample (e.g., the number and environments of the aforementioned O-H, C-H, N-H and S-H chemical bonds). These changes in spectral characteristics are also dependent on light scattering characteristics. For example, near infrared reflectance spectroscopy is sensitive to variation in particle size and particle size distribution. The particle size of ground cereal grains increases as hardness increases, and therefore hard grain flour has a higher apparent absorption value than soft flour. Also, a change in particle size causes a change in the amount of NIR radiation scattered in the sample, thereby causing a shift in the resulting absorbance spectra. Additionally, larger particles absorb more radiation and, thus, the absorption spectrum of larger particles will contain higher values than an absorption spectrum of smaller particles. Pomeranz and Williams (1990) “Wheat hardness: its genetic, structural, and biochemical background, measurement, and significance,” In: Advances in Cereal Science and Technology, Pomeranz, Ed., St. Paul, Minn., U.S.A.: American Association of Cereal Chemists, Inc., pp. 471-529; Hruschka (2001) “Data analysis: wavelength selection methods,” In: Near-infrared technology in the agriculture and food industries, supra, pp. 39-58.

NIRS has been used to make quantitative determinations of composition in agricultural products. See, e.g., Williams et al. (1982) Cereal Chem. 59:473-7; Williams et al. (1985) J. Agric. Food Chem. 33:239-44; Williams and Sobering (1993)J. Near Infrared Spectrosc. 1:25-32. Within cereals, NIRS has been applied to determine qualities including: seed composition in maize (See, e.g., Eyherabide et al. (1996) Cereal Chem. 73:775-8; Baye et al. (2006) J. Cereal Sci. 43:236-43), for example, the oil, protein, fiber, chlorophyll, and glucosinolate content of seed samples; cereal grain hardness (Downey et al. (1986) J. Sci. Food Agric. 37:762-6; Norris et al. (1989) Cereal Foods World 34:696-705; Osborne (1991) Postharvest News Inform. 2:331-4; Manley et al. (2002) J. Near Infrared Spectrosc. 10:71-6); and changes in carbohydrate and protein content of cereal grains during maturation (Gergely and Salgo (2005) J. Near Infrared Spectrosc. 13:9-17; Gergely and Salgo (2007) J. Near Infrared Spectrosc. 15:49-58).

In recent years, NIRS has been used in further applications, such as, for example, the detection of animal waste in food products (Liu et al. (2007) J. Food Eng. 81:412-8); determination of lipids in roasted coffee (Pizarro et al. (2004) Anal. Chim. Acta 509:217-27); verification of adulteration in alcoholic beverages (Pontes et al. (2006) Food Res. Inter. 39:182-9); monitoring of polymer extrusion processes (Rohe et al. (1999) Talanta 50:283-90); pharmaceutical applications (Quaresima et al. (2003) J. Sports Med. Phys. Fitness 43:1-13; Zhou et al. (2003) J. Pharm. Sci. 92:1058-65; Colón et al. (2005) J. Process Anal. Tech. 2:8-15; Blanco and Alcalá (2006) Euro. J. Pharm. Sci. 27:280-6; Sakudo et al. (2006) Biochem. Biophys. Commun. 341:279-84); and myriad other applications in food analysis (Osborne (2000) “Near-infrared spectroscopy in food analysis,” In: Encyclopedia of Analytical Chemistry, Meyers, Ed., Chichester: John Wiley & Sons, pp. 4069-81), as well as in generally unrelated fields, such as, for example, petrochemical analysis (Davidson et al. (1992) Proc. S.P.I.E. 1681:231-5; Macho and Larrechi (2002) Trends Anal. Chem. 21:799-806).

The NIR spectrum of a sample of an agricultural product essentially consists of a large set of overtones or combination bands. Due to the complexity of most agricultural samples, these spectra are extremely difficult to decipher. In general, NIR spectra of food constituents show broad bands that contain envelopes of overlapping absorptions. Osborne et al. (1993) Practical NIR Spectroscopy with Applications in Food and Beverage Analysis, Harlow, England: Longman Scientific & Technical. A sample of an agricultural product spectrum may be further complicated by wavelength-dependant scattering effects, instrument noise, temperature effects, and/or sample heterogeneities. Nicolaï et al. (2007) Postharvest Biol. Tech. 46:99-118. These influences make it difficult to assign specific absorption bands to specific sample components and functional groups. Therefore, multivariate data analysis using specific chemometrics techniques is required to extract relevant information buried in the spectral data resulting from NIR measurements.

Chemometrics is the science of extracting information from chemical systems by data-driven methods. Beebe et al. (1998) Chemometrics: a Practical Guide, NY, U.S.A.: John Wiley & Sons, Inc., pp. 1-8 and 26-55. Multivariate chemometric analysis involves extracting relevant information about the analyzed samples and variables of interest, thereby enabling reduction of the information into a smaller number of terms, and a residual consisting essentially of noise, so that the information may be more easily analyzed. Geladi (2003) Spectrochimica Acta Part B 58:767-82. The reduced number of terms will have increased stability due to noise or less useful information being removed from the data and may, therefore, lead to more consistent interpretations of results. Id.

Rapid multivariate, chemometric NIRS analysis of a plant-based sample to determine one or more characteristics using chemometric calibration models presents a unique challenge based on, for example, the NIR absorption wavelength and the nature of the relationship between the spectral data and the phenotype (linear or non-linear, etc.). The analysis is therefore dependent upon the development of chemometric calibration models, based on reference chemistry analysis of training samples. Because of the unique considerations posed for each sample type and each characteristic, a single chemometric analysis is not suitable for all traits.

Thus, useful calibration models must be developed in an application-dependent manner from generic chemometric software packages, such as GRAMS-PLS PLUS™ (Galactic Industries Corp.) or OPUS QUANT2™ (Bruker). The development of these NIRS calibration models is critical to the accurate analysis of seed samples to enable on-demand, time-critical generation of data. Furthermore, the evaluation of NIRS data typically requires a direct, visual inspection of the spectra to determine the presence of a biological trait or phenotype in the sample from which the NIRS data was obtained. Møller et al. “Near infrared reflectance spectroscopy and computer graphics visualises unique genotype specific physical-chemical patterns from barley endosperms,” In Cereal science and technology for feeding ten billion people: genomics era and beyond. (Options Méditerranéennes: Série A. Séminaires Méditerranéens 81. Meeting of the Eucarpia Cereal Section, Nov. 13-17, 2006, Lleida (Spain)) Molina Cano et al. (Eds.), Zaragoza: CIHEAM-IAMZ/IRTA (2008) pp. 253-9.

In typical NIRS platforms, the same instrument used to obtain the NIRS data is also used to perform chemometric analysis. However, these instruments do not contain sufficient memory to house the complicated calibration models that are required and also perform the data analysis. Thus, these platforms will experience a severe decrease in efficiency when performing data analysis of complex plant-based samples. The calibration models housed in the instrument additionally require continuous monitoring and updating as new reference chemistry data becomes available. Constraints such as the foregoing place a practical impediment to implementing more complex and sophisticated platforms and analyses, as there is a trade-off between maintaining adequate performance and improving the analysis.

### BRIEF SUMMARY OF THE DISCLOSURE

Described herein is the development of an automated platform for NIRS data analysis that, in some embodiments, addresses particular challenges associated with increasing the throughput of NIRS analysis of plant-based samples and identifying an improved chemometric model for analysis of a specific plant or sample characteristic. In particular embodiments, NIRS data analysis of a plant-based sample (e.g., seed compositional analysis of a seed sample) may be used to make a breeding selection for one or more trait(s) or phenotype(s) that are involved in determining the sample characteristics (e.g., fatty acid profile, protein content, fiber content, chlorophyll content, etc. in a seed sample). In these and further embodiments, the invention provides a global NIRS analysis system that may be implemented across different instrument types and environments for multiple crops and multiple traits, wherein the analysis system may provide specific preferred analyses for each of the crops and traits.

According to the foregoing, described herein are systems and methods for the analysis of NIRS data acquired from a plant sample. Such systems and methods may be utilized, for example and without limitation, to determine a chemometric model of NIRS data to identify a plant trait of interest; to determine at least one characteristic in a plant sample obtained from a plant; to determine a characteristic of interest in a plant material; to determine a trait of interest in a plant; and/or to select a plant comprising a trait of interest (e.g., for propagation in a plant breeding program).

In some embodiments, a system according to the invention may comprise one or more of the following: a near infrared (NIR) spectrometer; a processor, for example, containing a database comprising a plurality of chemometric models of NIR spectroscopy (NIRS) data from a plant sample corresponding to one or more characteristic(s) of interest; and analytical programming, for example, for utilizing a plurality of chemometric models to determine a relationship between NIRS data and a characteristic(s) of interest. In particular embodiments, a processor utilizes each of a plurality of chemometric models to determine a relationship between NIRS data and a characteristic(s) of interest, wherein the processor identifies a chemometric model that closely relates the NIRS data and the characteristic(s) of interest. In particular embodiments, a processor utilizes a chemometric model (e.g., a chemometric model that closely relates NIRS data and a characteristic(s) of interest) to determine the characteristic(s) of interest in a plant sample from which NIRS data has been obtained. In some examples, a system of the invention may comprise a NIR spectrometer and a processor, where the spectrometer and the processor are not physically connected.

In some embodiments, a method according to the invention may comprise one or more of the following: a plant sample to be analyzed; NIRS data acquired from the plant sample; a computer readable storage medium, for example, containing a database comprising multiple chemometric models for analyzing the NIRS data to determine a characteristic of the sample; a computer, for example, comprising analytical programming for utilizing the chemometric models to determine a relationship between the NIRS data and the characteristic of the sample; parameters selected for use in each of the chemometric models; utilization of each of the chemometric models to determine a relationship between the NIRS data acquired from the plant sample and the characteristic of the sample; and determination of the chemometric model that most closely relates the NIRS data acquired from the plant sample and the characteristic of the sample. In particular examples, the chemometric model that most closely relates the NIRS data acquired from the plant sample and the characteristic of the sample identifies the characteristic of the sample. In particular examples, the characteristic of the sample is a plant trait of interest, or is a characteristic that is related to, or indicative of, a plant trait of interest.

In some aspects, a method and/or system of the invention may comprise a user interface (e.g., a web-based interface). In particular examples, a user interface allows the user to specify the plant from which a plant sample was obtained, and a plant trait of interest for analysis. A method or system of the invention may comprise means for identifying outlying data and excluding such data from analysis. In some examples, a method or system of the invention may comprise means for normalizing NIR data according to the NIR instrument with which the data was obtained. In particular embodiments, a method may comprise transmitting an electronic message comprising the relationship between NIR data and a plant trait of interest, as determined by a chemometric model that identifies the plant trait of interest.

In some aspects, a method according to the invention is performed in a fully automated manner (e.g., utilizing a system of the invention that may function in a fully automated manner), which may decrease the labor required to analyze NIRS data from plant samples to determine at least one characteristic or trait in the plant sample or the plant material from which the sample was obtained. In particular examples, the determination of a characteristic or trait in the plant sample may be utilized to determine a trait in the plant from which the sample was obtained.

The foregoing and other features will become more apparent from the following detailed description of several embodiments, which proceeds with reference to the accompanying figures.

### BRIEF DESCRIPTION OF THE FIGURES

FIG. 1(a-h) includes an example of PYTHON™ code for an exemplary web interface according to some embodiments.

FIG. 2(a-g) includes an example of MATLAB™ (MathWorks®, Natick, Mass.) code with comments for an automated NIRS data analysis program according to some embodiments.

FIG. 3 includes a depiction of the training data distribution for total saturated fatty acid content.

FIG. 4 includes a comparison of several methods for capturing the relationship between the spectra and the actual value of the total saturated fatty acid content trait. The X-axis represents original values. The Y-axis represents values predicted by specific models.

FIG. 5 includes a depiction of the training data distribution for C18:1cis9 fatty acid content.

FIG. 6 includes a comparison of several methods for capturing the relationship between the spectra and the actual value of the C18:1cis9 fatty acid content trait. The X-axis represents original values. The Y-axis represents values predicted by specific models.

FIG. 7 includes a depiction of the training data distribution for C18:1cis11 fatty acid content.

FIG. 8 includes a comparison of several methods for capturing the relationship between the spectra and the actual value of the C18:1cis11 fatty acid content trait. The X-axis represents original values. The Y-axis represents values predicted by specific models.

FIG. 9 includes a depiction of the training data distribution for C18:1 fatty acid content.

FIG. 10 includes a comparison of several methods for capturing the relationship between the spectra and the actual value of the C18:1 fatty acid content trait. The X-axis represents original values. The Y-axis represents values predicted by specific models.

FIG. 11 includes a depiction of the training data distribution for C18:2 fatty acid content.

FIG. 12 includes a comparison of several methods for capturing the relationship between the spectra and the actual value of the C18:2 fatty acid content trait. The X-axis represents original values. The Y-axis represents values predicted by specific models.

FIG. 13 includes a depiction of the training data distribution for C18:3 fatty acid content.

FIG. 14 includes a comparison of several methods for capturing the relationship between the spectra and the actual value of the C18:3 fatty acid content trait. The X-axis represents original values. The Y-axis represents values predicted by specific models.

FIG. 15 includes a depiction of the training data distribution for C16:0 fatty acid content.

FIG. 16 includes a comparison of several methods for capturing the relationship between the spectra and the actual value of the C16:0 fatty acid content trait. The X-axis represents original values. The Y-axis represents values predicted by specific models.

FIG. 17 includes a depiction of the training data distribution for C18:0 fatty acid content.

FIG. 18 includes a comparison of several methods for capturing the relationship between the spectra and the actual value of the C18:0 fatty acid content trait. The X-axis represents original values. The Y-axis represents values predicted by specific models.

FIG. 19 includes a depiction of the training data distribution for C20:0 fatty acid content.

FIG. 20 includes a comparison of several methods for capturing the relationship between the spectra and the actual value of the C20:0 fatty acid content trait. The X-axis represents original values. The Y-axis represents values predicted by specific models.

FIG. 21 includes a depiction of the training data distribution for C24:0 fatty acid content.

FIG. 22 includes a comparison of several methods for capturing the relationship between the spectra and the actual value of the C24:0 fatty acid content trait. The X-axis represents original values. The Y-axis represents values predicted by specific models.

FIG. 23 includes a depiction of the training data distribution for C12:0 fatty acid content, and a comparison of several models for capturing the relationship between the spectra and the actual value of the C12:0 fatty acid content trait.

FIG. 24 includes a depiction of the training data distribution for C16:1 fatty acid content.

FIG. 25 includes a comparison of several methods for capturing the relationship between the spectra and the actual value of the C16:1 fatty acid content trait. The X-axis represents original values. The Y-axis represents values predicted by specific models.

FIG. 26 includes a depiction of the training data distribution for C20:1 fatty acid content.

FIG. 27 includes a comparison of several methods for capturing the relationship between the spectra and the actual value of the C20:1 fatty acid content trait. The X-axis represents original values. The Y-axis represents values predicted by specific models.

FIG. 28 includes a depiction of the training data distribution for C20:2 fatty acid content.

FIG. 29 includes a comparison of several methods for capturing the relationship between the spectra and the actual value of the C20:2 fatty acid content trait. The X-axis represents original values. The Y-axis represents values predicted by specific models.

FIG. 30 includes a depiction of the training data distribution for C22:0 fatty acid content.

FIG. 31 includes a comparison of several methods for capturing the relationship between the spectra and the actual value of the C22:0 fatty acid content trait. The X-axis represents original values. The Y-axis represents values predicted by specific models.

FIG. 32 includes a depiction of the training data distribution for C24:1 fatty acid content.

FIG. 33 includes a comparison of several methods for capturing the relationship between the spectra and the actual value of the C24:1 fatty acid content trait. The X-axis represents original values. The Y-axis represents values predicted by specific models.

FIG. 34 includes a depiction of the training data distribution for C14:0 fatty acid content.

FIG. 35 includes a comparison of several methods for capturing the relationship between the spectra and the actual value of the C14:0 fatty acid content trait. The X-axis represents original values. The Y-axis represents values predicted by specific models.

FIG. 36 includes a depiction of the training data distribution for moisture content.

FIG. 37 includes a comparison of several methods for capturing the relationship between the spectra and the actual value of the moisture content trait. The X-axis represents original values. The Y-axis represents values predicted by specific models.

FIG. 38 includes a depiction of the training data distribution for total oil content.

FIG. 39 includes a comparison of several methods for capturing the relationship between the spectra and the actual value of the total oil content trait. The X-axis represents original values. The Y-axis represents values predicted by specific models.

FIG. 40 includes a depiction of the training data distribution for protein content.

FIG. 41 includes a comparison of several methods for capturing the relationship between the spectra and the actual value of the protein content trait. The X-axis represents original values. The Y-axis represents values predicted by specific models.

FIG. 42 includes a depiction of the training data distribution for glucosinolate content.

FIG. 43 includes a comparison of several methods for capturing the relationship between the spectra and the actual value of the glucosinolate content trait. The X-axis represents original values. The Y-axis represents values predicted by specific models.

FIG. 44 includes a depiction of the training data distribution for chlorophyll content.

FIG. 45 includes a comparison of several methods for capturing the relationship between the spectra and the actual value of the chlorophyll content trait. The X-axis represents original values. The Y-axis represents values predicted by specific models.

FIG. 46 includes a depiction of the training data distribution for acid detergent fiber (ADF) content.

FIG. 47 includes a comparison of several methods for capturing the relationship between the spectra and the actual value of the ADF content trait. The X-axis represents original values. The Y-axis represents values predicted by specific models.

FIG. 48 includes a screen-shot depicting the web interface for spectral analysis according to some embodiments.

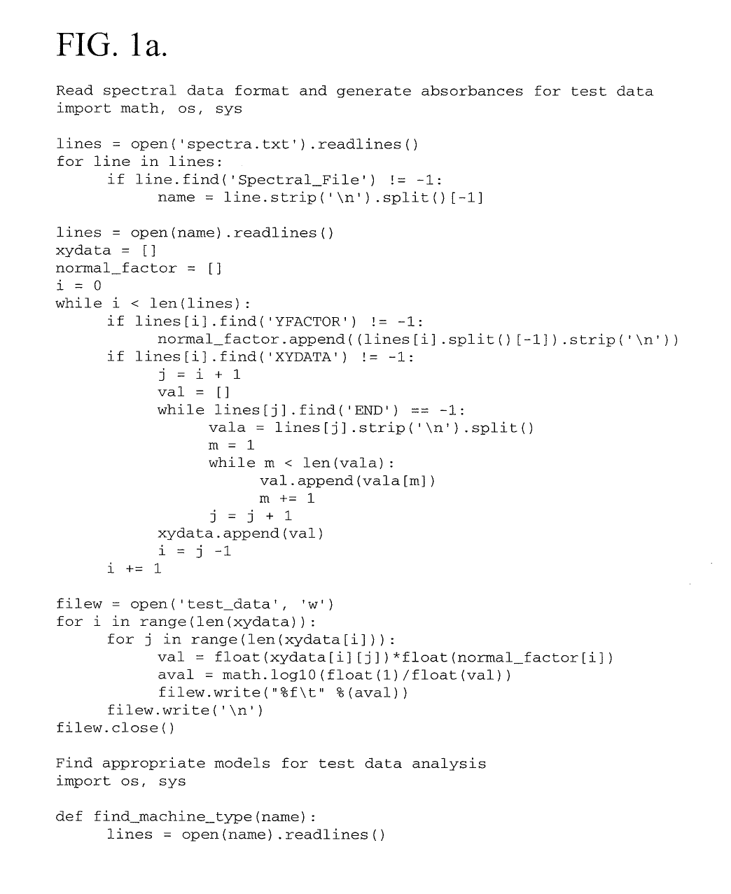

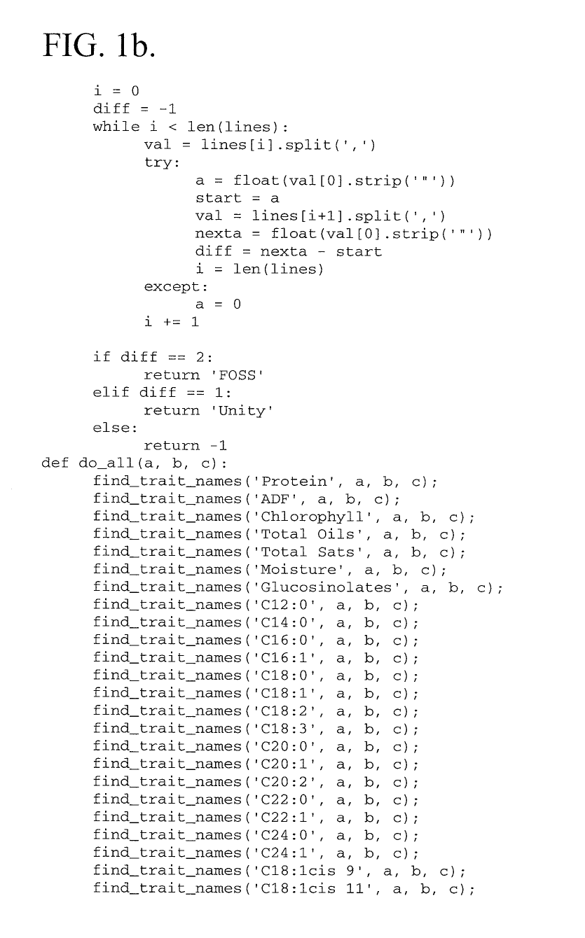

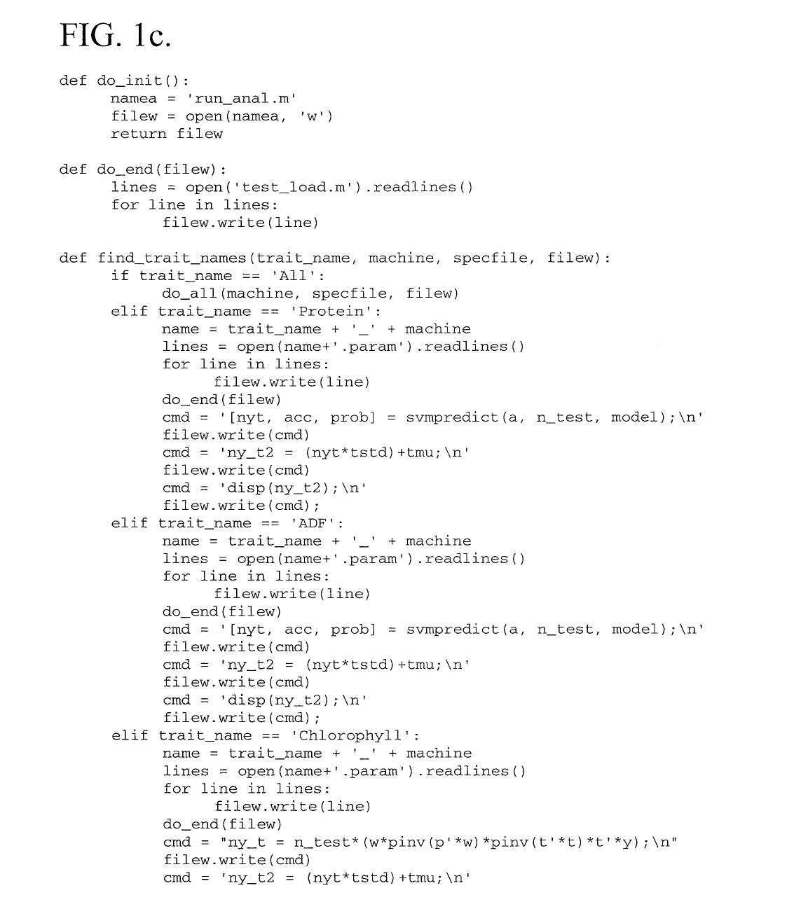

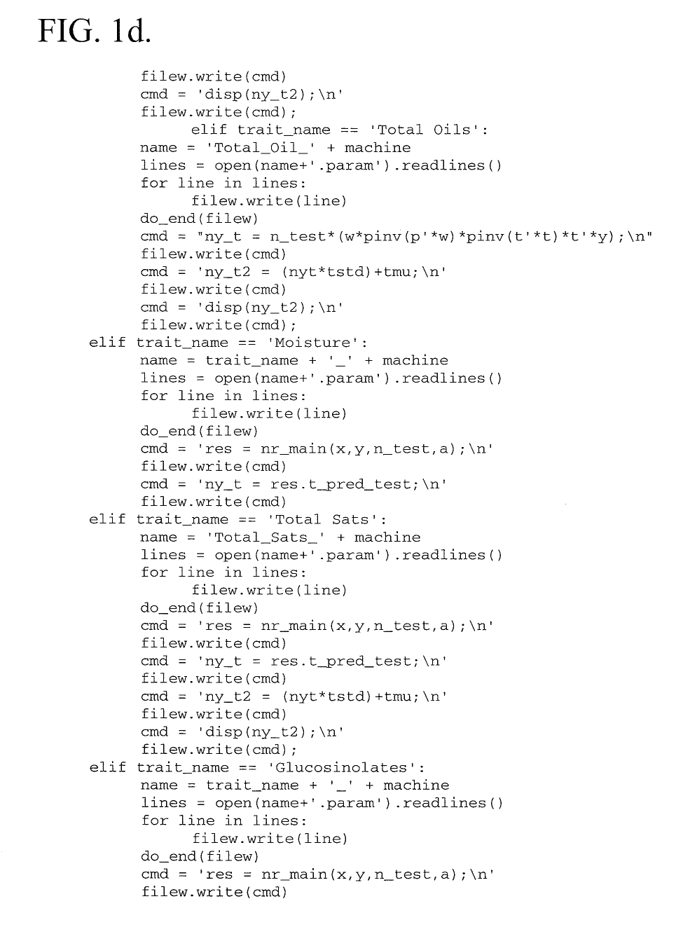

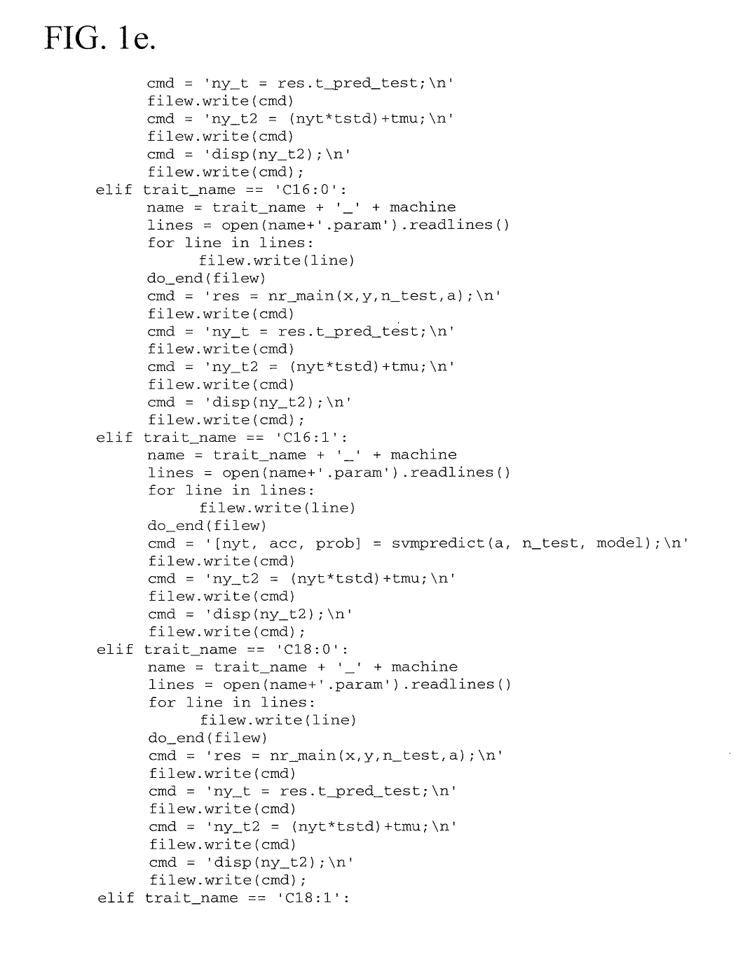

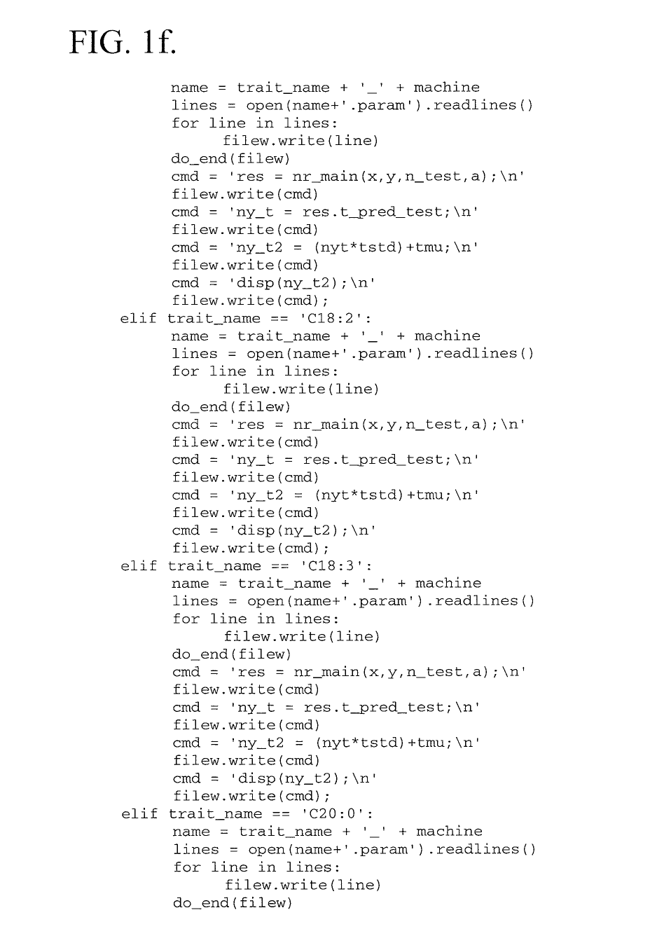

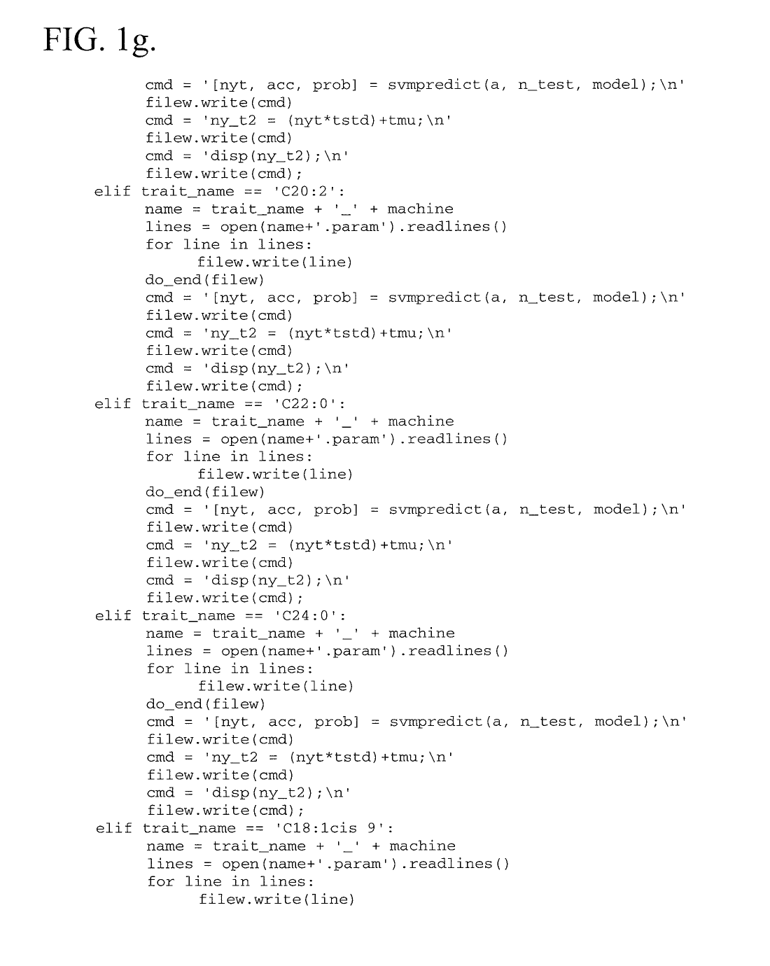

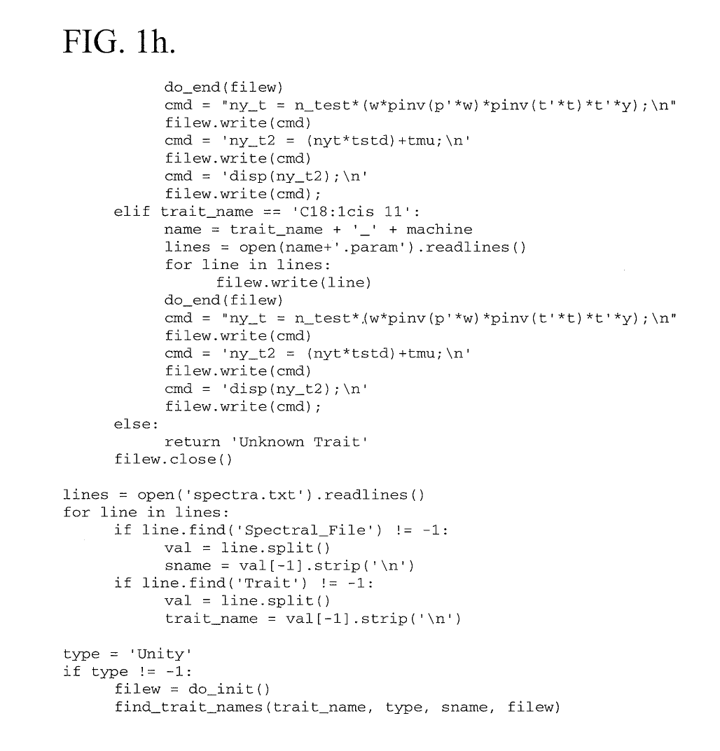

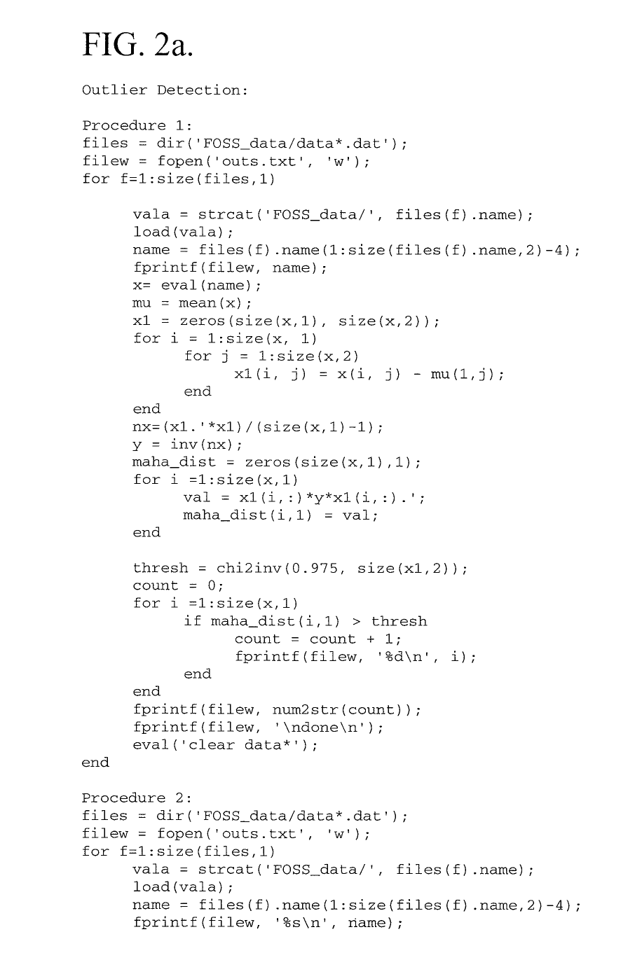

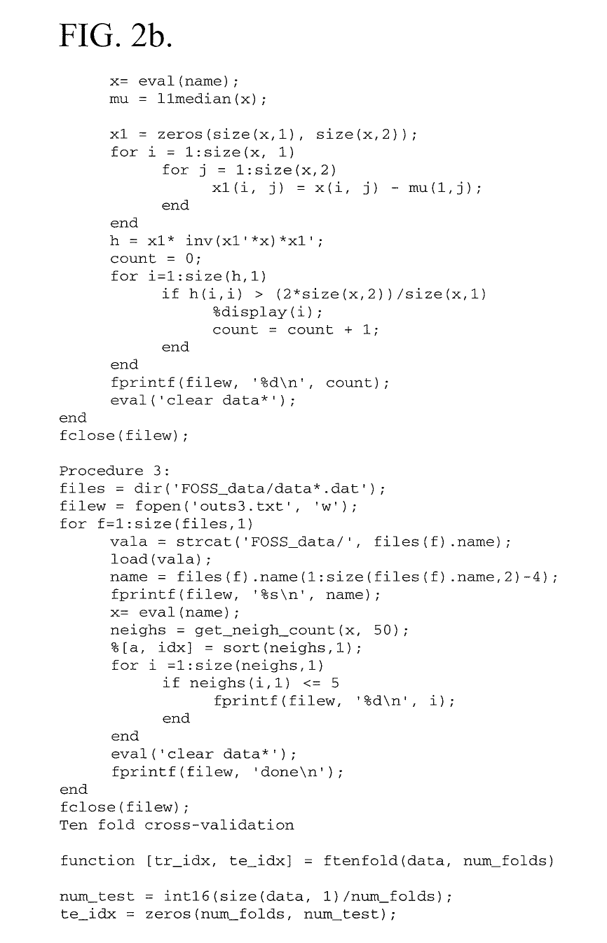

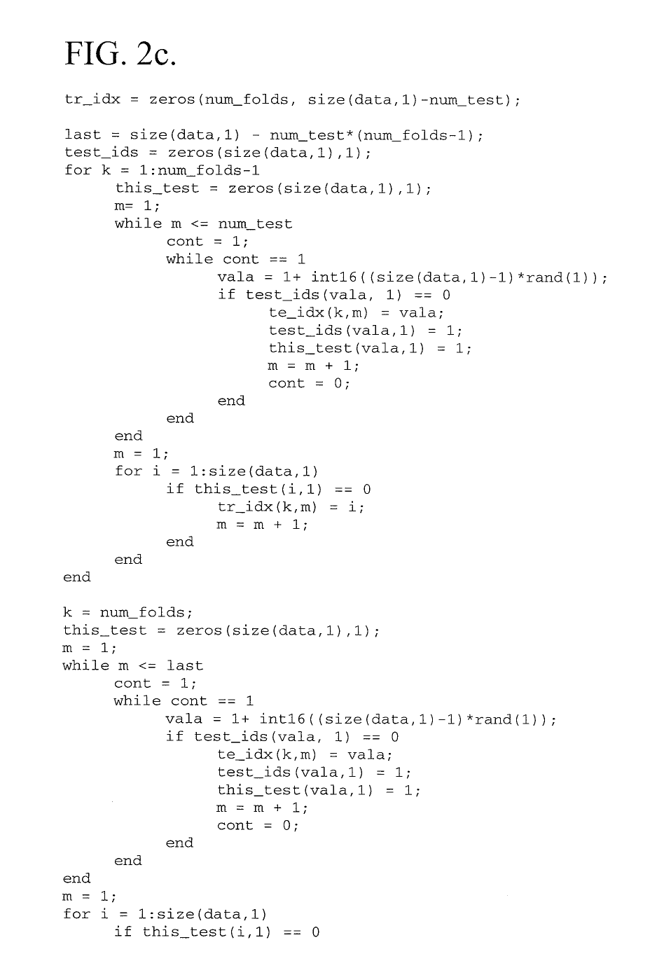

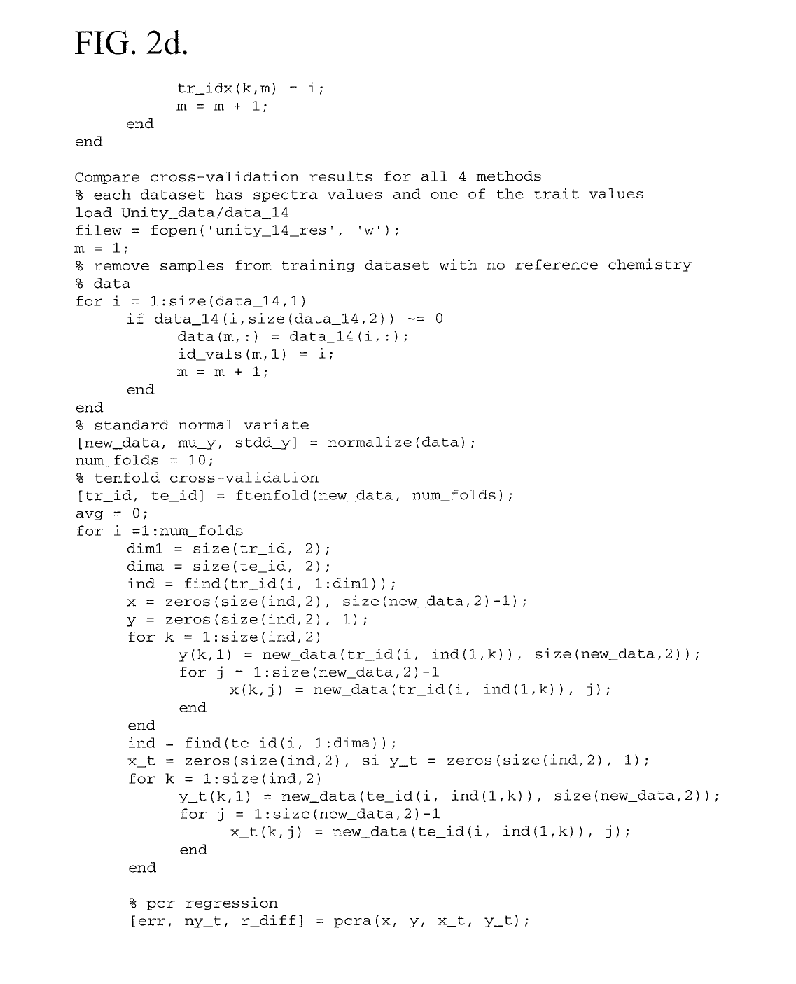

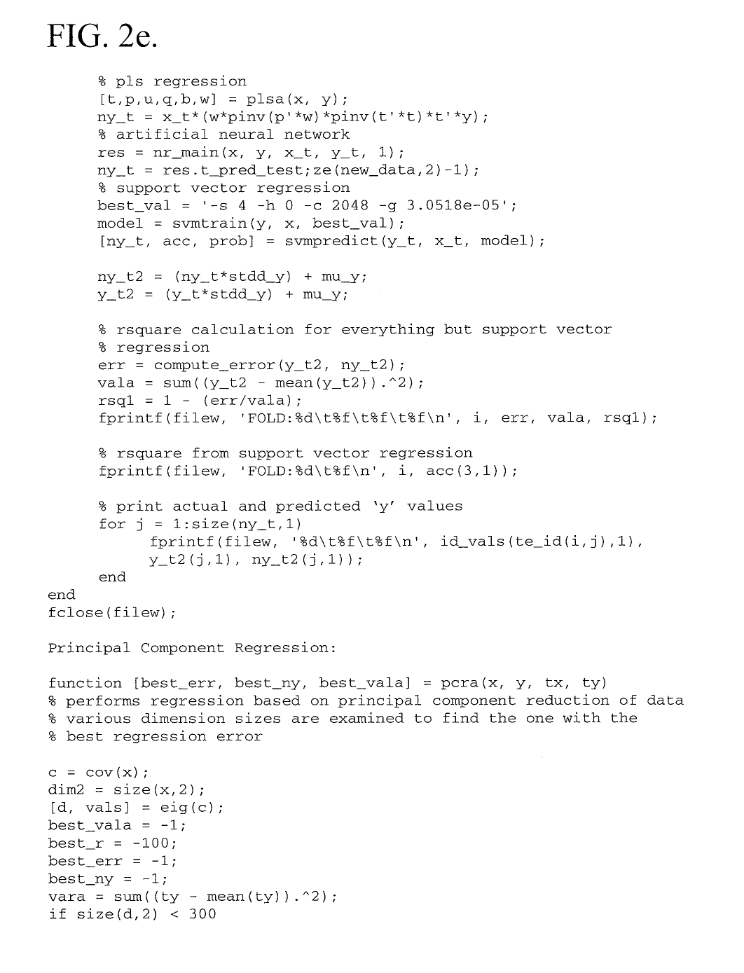

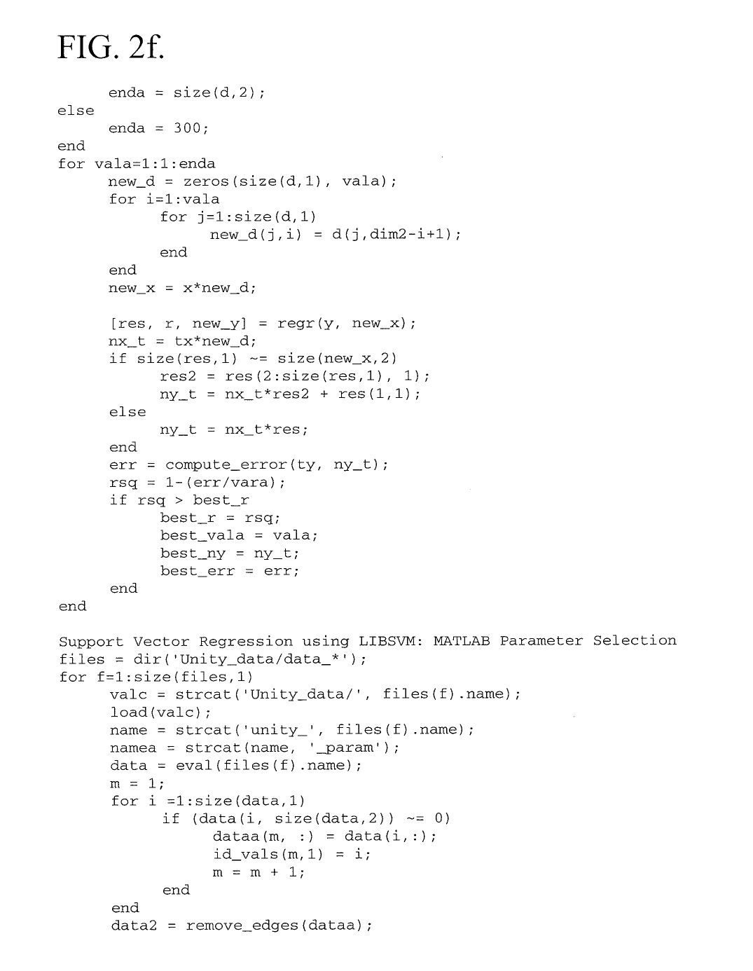

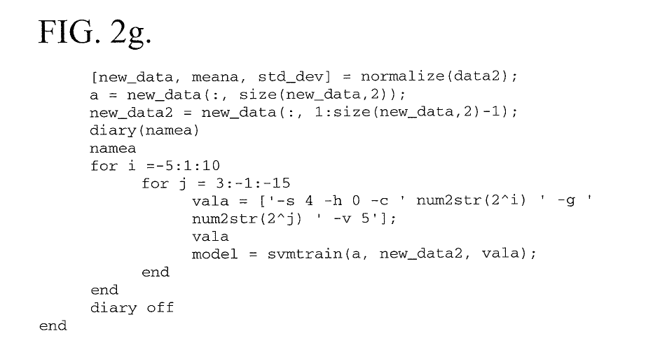

### DETAILED DESCRIPTION

### I. Overview of Several Embodiments

Agricultural plant products increasingly incorporate improvements in product quality and availability due to the use of crops that have been enhanced. Enhanced crops may be produced either by genetic engineering (e.g., recombinant genetics techniques), or by selective breeding programs. Even traditional crop improvement practices may result in plants with changed genetics and enhanced properties attributable thereto. For example, enhanced corn varieties may provide altered fatty acid profiles (e.g., increased oil content, reduced trans-fatty acid content, increased oleic acid content, and decreased linolenic acid content) or increase the opportunity for efficient production of ethanol from maize kernel starch. The physical and genetic composition of improved crop plants is different from corresponding conventional crop plants of the same species. For example, high-oil corn, high-sucrose soybeans, and low-linolenic acid canola are all distinguishable by their characteristic chemical compositions. These crop plants are also distinguishable by characteristic genotypes, such as can be passed on to progeny plants created from the same germplasm.

It is important to be able to determine the presence of a characteristic chemical composition and/or the genotype of the plant(s) from which a plant product has been produced. For example, the use of genetically engineered crops and sale of plant products produced therefrom are increasingly the focus of commercial regulation, and even when their sale is not regulated, consumers often desire to be able to ascertain with certainty whether a plant product was produced from a genetically engineered plant. Furthermore, growers and their suppliers require the capability to determine the source or make-up of crops in the field, for example, to control the distribution of proprietary technology and to avoid unauthorized use of the same. An additional demand for typing plants exists in the design and implementation of directed breeding or genetic engineering strategies. Such strategies generally produce an extremely large number of plants that must be analyzed for the presence of a trait of interest, for example, in order to make selections of desirable plants for further use and/or propagation.

One problem associated with the use of conventional procedures to determine whether plant products have been produced from genetically enhanced crops, or to quantitatively determine the percentage of genetically modified substances in a plant material, is that such procedures typically involve direct genetic analysis (e.g., by PCR and/or DNA fingerprinting) or more rarely may involve the detection and chemical analysis of specific proteins produced by specific genes or alleles. These procedures are time-consuming and/or expensive, and they may yield only qualitative or semi-quantitative results. Further, and of particular importance to plant breeding programs, genetic analyses do not determine the effectiveness of particular alleles in modifying or creating a desirable output trait. Classical genetic analysis is focused on individual genes and traits, assuming something close to free distribution. However, most gene, trait, and quality complexes in plants are strongly dependent upon each other.

Methods for evaluating the outcome of a genetic modification or breeding effort should be able to be employed with very small sample sizes. For example, in seed crops, the evaluation is best performed on a single-seed basis, because only the seeds may segregate with respect to the desired trait. For example, in corn, a specific transgenic event or conventional breeding cross may only produce a single ear with segregating kernels. In contrast, seed supplies sufficient for bulk chemical analysis may require multiple generations of seed production or increased replicate measurements in a single generation.

This disclosure, at least in part, addresses these insufficiencies of conventional procedures by providing economical and efficient methods and systems for the analysis of small plant samples (e.g., seeds, vegetative plant material, and root material) to identify and quantify one or more trait(s) in the plant from which the plant sample was obtained. Further, this disclosure provides improved chemometric multivariate analysis methods to predict and determine traits from measurable properties of plant samples utilizing a particular improved chemometric model.

Described herein is a fast and robust methodology to compare multiple state-of-the-art chemometric models for a plurality of traits and to select and improve a more accurate model based on cross-validation results. The accuracy of chemometric data analyses techniques varies with respect to particular traits. Therefore, embodiments of the invention have the capability to compare the accuracy of a calibration model for each trait using different algorithms and to pick the one that best models the relationship between the NIRS data and the trait. This methodology allows each trait to be modeled as accurately as possible, and it also allows for a deeper understanding of the relationship between NIR spectra and the modeled trait.

In some embodiments, the identification of the right parameters for each model may be automated, such that the selection and improvement of a more accurate model may be made without expending the valuable resources required to perform these tasks manually. Additionally, the accuracy of calibration models is largely influenced by the presence of outliers in the data. These outliers could represent true variations in the trait or be a result of incorrect sample processing or poor quality samples. Since these outliers could greatly influence the distribution of data, it is essential to identify outliers in before calibration model development.

A method and/or system of the invention may also include automated sample processing. An online web-interface combined with a time-based job scheduler (e.g., a cron job) on a server may ensure that data files, when submitted through the online interface, are analyzed by the server automatically without requiring human intervention. The online interface may automatically identify the resolution of the instrument that collected the spectral data, and correct the data for the instrument, thus making the chemometrics analyses globally accessible and able to be implemented across various instrument-types.

The broad utility and applicability of the invention has been demonstrated herein using detailed working examples that are recognized applications of NIR analysis in agriculture. For example, NIRS data was acquired utilizing 3 different spectroscopic instruments (Bruker, Foss, and NIR) from seed samples of 2 different crops (Canola and Sunflower). Systems and methods of the invention were used to analyze this NIRS data and determine, e.g., seed compositional traits in the samples, thereby demonstrating by example the advantages of embodiments of the invention. In some embodiments, systems and methods of the invention may be used to analyze spectral data obtained from any plant material from which NIRS data may be obtained (e.g., liquids, solids, and granular material).

### II. Abbreviations

ADF acid detergent fiber
ANN artificial neural networks
AOTF acousto-optic tunable filter
CR continuum regression
LCTF liquid crystal tunable filter
LRR latent root regression
LWR locally weighted regression
MLR multiple linear regression
MSC multiplicative scatter correction
NIR near infrared
NIRS near infrared spectroscopy
ODIN a graph theoretic approach based on neighborhood calculation
OLS ordinary least squares
OSC orthogonal signal correction
PCA principal component analysis
PCovR principal covariates regression
PCR principal component regression
PGP prism-grating-prism filter
PLS partial least squares
PLS-DA partial least squares discriminant analysis
RR ridge regression
SIR sliced inverse regression
SNV standard normal variate
SVM Support Vector Machines
YSC yellow seed coat

### III. Terms

Automated: As used herein, the term “automated” refers to a method that is self-executing following an initial command from a user. By way of illustration, in particular embodiments, a user identifies a plant sample and a trait of interest to be determined in the plant sample, and initiates an automated analysis method of the invention. In these particular embodiments, the user next receives an output of the method that identifies a useful chemometric analysis model for the trait of interest and a determination of the trait of interest in the plant sample, without requiring further action on the part of the user.

Chemometric: As used herein, the term “chemometric” refers to the use of statistical and mathematical techniques to analyze chemical data, and the entire process whereby data are transformed into information used for decision making purposes. Geladi (2003), supra. Chemometrics enables the reduction of information contained in enormous data matrices to more easily understood information and a residual noise component. Id. General information regarding chemometrics and chemometric analysis techniques may be found in, for example, Beebe et al. (1998) Chemometrics: a Practical Guide, NY, U.S.A.: John Wiley & Sons, Inc. For specific information regarding chemometric analysis techniques of NIRS data, see, e.g., Heise and Winzen (2002) “Chemometrics in near-infrared spectroscopy,” In: Near-Infrared Spectroscopy: Principles, Instruments, Applications, supra, pp. 125-61.

In a multivariate chemometric data analysis process, a chemometric analysis is applied to a data matrix in order to extract relevant information from the matrix. Analysis results for each object may be expressed in a variety of ways, for example and without limitation, absorbances, concentrations, peak heights, integrals, and particle counts. A general term to describe these expressions is “variable.” In some embodiments of the invention, NIRS data comprises a variable including the transmission or absorption of NIR radiation at particular wavelengths. When K variables are measured for I objects, the resulting data form a data matrix of size I×K. Chemometrics involves taking the resulting data matrix and extracting hidden and meaningful information about the objects and variables, which is made possible by correlation between many of the variables.

Variables may be “homogeneous” or “heterogeneous.” Variables that are measured in the same units and that can be ordered are homogenous. For example, when the variables are absorbances (or transmittance) measured at different wavelengths, they are homogeneous, because they are measured in the same units and can be ordered by increasing wavelength. When variables come from different instruments, they may be heterogeneous. For example, a collection of variables including temperature, pressure, pH, and viscosity are heterogeneous, because these variables are in different units and their order does not matter. It is also possible to have mixed variables (i.e., homogeneous variables, such as an NIRS spectrum, may be mixed with heterogeneous variables.

Chemometric analysis operates on the principle that the data matrix contains redundant information that can be reduced. The reduced terms are easier to interpret and understand, have more stability, and are separated from a residual that contains noise and/or less useful information. The reduced terms are also sometimes referred to as “latent variables.”

Different forms of data analysis (e.g., whether the analysis includes data exploration, classification, or curve resolution) require the utilization of different chemometrics techniques. Classification of data into different groups may be performed through unsupervised classification techniques such as principal component analysis (PCA) if no information is known about the samples, or through supervised classification techniques (e.g., partial least squares discriminant analysis (PLS-DA)) when sufficient information is known about the sample.

Global: A method or system of the invention may be referred to as “global.” As used herein, the term “global” refers to a method or system that may be used to analyze data obtained at different geographical locations (which locations may comprise different crop environments) and using different spectroscopic instruments.

Provide: As used in the description of methods herein, the term “provide” refers to the making available of a particular article. For example, NIRS data may be provided by a variety of acts, for example and without limitation, collecting the data from a spectrometer, and obtaining the data from a source where it was collected from a spectrometer.

Remote: As used herein, the term “remote” refers only to the existence of a physical separation between the NIRS instrument and the processor. “Remoteness” does not suggest that the location of a first instrument or article is isolated geographically or technologically from a second instrument or article.

Sample: As used herein, the term “sample” refers to the object of an analysis technique. For example, some embodiments include the NIRS characterization and/or analysis of a plant sample, wherein the sample is a plant part or object prepared from a plant part. However in some embodiments, a whole plant may be characterized and/or analyzed using methods of the invention (e.g., by phenotype and/or genotype). Thus for the purposes of this disclosure, a whole plant that is analyzed may be included within the meaning of the term, “sample.”

Telecommunications link: A “telecommunications link” refers to any means whereby a connection can be effected between a device (e.g., an NIR spectrometer) and a processor, for example, to exchange information or data or communicate the information unidirectionally. In some examples, the connection is via the interne, but may also include a hard wire connection, wireless connection, tower-based or satellite-based wireless connection, or combinations of any of the foregoing.

Trait: As used herein, the term “trait” refers to a measurable characteristic of an individual. The terms “trait” and “phenotype” are used interchangeably herein. Of particular interest in some embodiments of the invention are traits that are identifiable from NIRS data. For example, a trait of interest may be a seed compositional trait that is identifiable from NIRS data obtained from a seed sample.

### IV. System for NIR Spectral Analysis

When analyzing plant products, characteristics of the crop from which the product was obtained must be determined with a minimum of time delay. Furthermore, the characteristics of the plant product in one location should be able to be compared with the characteristics of the same plant product at a separate location. These locations may often be separated by a substantial geographic distance. In some embodiments, a system of the invention may have the advantage that it is capable of analyzing NIRS data from plant products to determine a characteristic at multiple locations, whether or not geographically distant, and to separate information regarding the characteristic from noise and/or contributions to the NIRS data made by different instruments or instrument types. Thus, embodiments of the invention provide a global system for NIRS data analysis.

Some embodiments include a processor. A processor may be implemented using any suitable electronic device or combination of devices (e.g., one or more servers) capable of hosting chemometric models, applying the models to NIRS data, and generating and outputting results. A plurality of chemometric models may be hosted in a processor as a library of chemometric models. A library of chemometric models stored on a processor may be modified to incorporate calibration updates, add new calibration models, delete unwanted calibration models, and/or to expand the capabilities for analyzing new traits or crops. In particular embodiments, modifications to a library of chemometric calibration models may be done without making any changes to the hardware or software of a device implementing the processor. In embodiments, a library of calibration models is developed from NIRS data containing information regarding the trait or characteristic the models are meant to determine. The different models in the library may be applied to the NIRS data, and their performance compared, so as to determine a more accurate model among the models in the library. The more accurate model may then be used to compute values of traits from the NIRS data.

In some embodiments, a system for NIR spectral analysis may be used to determine one or more characteristics (e.g., traits) of plant samples located in distant locations utilizing a single chemometric model for each characteristic. NIRS data may be acquired using a spectrometer in one location, and analyzed using a remote processor. For example and without limitation, the spectrometer may be located at least about 100 meters, about 1 mile, about 10 miles, about 100 miles, about 200 miles, about 400 miles, about 600 miles, about 1000 miles, about 2000 miles, or more from an electronic device implementing the processor.

Some embodiments include a specialized computer comprising a processor and specific analytical programming. The processor may be a computer system that may be used to store and manipulate a library of chemometric models, to execute analytical programming to perform a chemometric analysis, and/or to communicate analysis results. In particular embodiments, the processor may be a single device. However, in further embodiments, the processor is not a single device, for example, the processor may reside on multiple computer servers, where some duplication may be provided for redundancy, and other duplication may be provided to mirror servers. Thus, as used herein, the term “processor” may refer to a group of singular processors.

In some embodiments, one or more analytical program(s) may utilize a chemometric model identified by the system as more accurate to determine a relationship between the NIRS sample data and a characteristic of interest, and output a result including the relationship. Furthermore in particular embodiments, the analytical program(s) may operate to display the results of the analytical programming (e.g., the more accurate chemometric model for the characteristic of interest, changes to the model made in response to the new data, and/or the relationship determined by the model).

### Web Interface

In some embodiments, a system of the invention may include software operating on an NIR spectrometer, or electronic device attached thereto (e.g., via a telecommunications link), that assembles NIRS data obtained from a plant sample and communicates the NIRS data to a web interface. The web interface may be configured to instantiate the interface between the NIR spectrometer and a processor, move the NIRS data into a directory, and instantiate one or more analytical program(s) that begin reading NIRS data in the directory. These steps may all occur on a web server.

In some embodiments, a web interface may allow the practitioner to easily upload NIRS data (e.g., data acquired by the practitioner, and data previously acquired that is stored in a database), and specify information including, for example and without limitation, the characteristic of interest to be determined by chemometric analysis, the plant from which the plant sample was obtained, and/or the spectrometer instrument type. In particular embodiments, the instrument type may be automatically identified by software from the spectral data in the file. The interface may then be utilized to submit the uploaded NIRS data, and the values of the different options selected, to a processor. In these embodiments, since the NIRS data is submitted online via a web interface, operation of the system depends in part on maintaining internet connectivity. However, if a break in internet connectivity occurs, the NIRS data may be stored on the instrument and submitted via the web interface when the connection is restored.

In some embodiments, the practitioner does not need to upload the NIRS data to a server. In these and further embodiments, a time-based job scheduler (e.g., a cron job) may regularly monitor a directory that stores NIRS data on each instrument, and upload stored data automatically. In these embodiments, NIRS data is uploaded at designated intervals whenever internet connectivity is available. For example, the job scheduler may search for a new NIRS data file at intervals of about 24 hours, about 12 hours, about 6 hours, about 4 hours, about 2 hours, about 1 hour, about 45 minutes, about 30 minutes, about 20 minutes, about 10 minutes, about 7 minutes, about 5 minutes, about 3 minutes, about 2 minutes, about 1 minute, or less. In particular embodiments, a time-based job scheduler may begin analysis of uploaded data and determination of a more accurate chemometric model in an automated manner, thereby allowing for data analysis at times when the practitioner is not available (e.g., at night during rest, and during the performance of other tasks).

A web interface may improve the throughput of NIRS analysis of plant samples, for example, by decoupling the NIRS data collection from the data analysis. The decoupling of NIRS data collection from data analysis may allow for the housing of the chemometric models in the same facility as the spectrometer and not at a distant location (as may have been required in certain conventional procedure in order to optimize performance), thereby making it easier to continuously improve calibration models based on the latest available chemometric techniques and wet-chemistry data. In some embodiments, housing the chemometric models in the same facility or instrument as the spectrometer may also relieve chemometric analyses from memory and processor bottlenecks that are typical when using remote instruments. On-site processor function may increase the computational speed of NIRS data analysis, thereby giving the practitioner the ability to make time-critical decisions. This configuration may also allow the practitioner to have greater access to the storage and retention of each of the samples analyzed, and also accommodate faster incorporation of any novel phenotypes observed during spectral analysis.

Therefore according to the foregoing, in some embodiments, NIRS data may be acquired using a spectrometer in one location, and analyzed using a nearby processor. For example and without limitation, the spectrometer may be located less than about 100 meters, about 50 meters, about 10 meters, about 5 meters, or about 1 meter or less from an electronic device implementing a processor housing the models. For example, an electronic device housing the processor may be physically connected to the spectrometer.

In some embodiments, after NIRS data has been uploaded, whether automatically or manually by the practitioner, a more accurate chemometric model for the analysis of a characteristic of interest in the plant sample from which the NIRS data was obtained may be automatically selected. In particular embodiments, a set of values for the characteristic of interest that are predicted by the selected model may also be automatically generated using the selected chemometric analysis. Subsequently, an electronic message may be sent to the practitioner and/or further designated recipients that contains the selected model and/or the results of the analysis, or with information to access a file or document that contains this information.

### NIRS Instruments

An NIRS imaging instrument may comprise the following components: an illumination source; a camera; a spectrograph; and a detector, which may all be coupled to a computer. For general information regarding NIRS systems and their components, see, e.g., Reich (2005) Adv. Drug Delivery Rev. 57:1109-43; Grahn and Geladi (2007) Techniques and Applications of Hyperspectral Image Analysis, Chichester, England: John Wiley & Sons Ltd., pp. 1-15 and 313-34; and Gowen et al. (2008) Eur. J. Pharm. Biopharm. 69:10-22. For macroscopic or microscopic images, a focusing lens or a microscope objective may also be used.

Illumination sources comprised in an NIRS imaging instrument may include, for example and without limitation, tungsten halogen lamps, and xenon gas plasma lamps. Filters are used to select the wavelengths to be measured. For example and without limitation, an NIRS imaging instrument may comprise a liquid crystal tunable filter (LCTF); an acousto-optic tunable filter (AOTF); or a prism-grating-prism filter (PGP). The camera unit of an NIRS imaging instrument may include, for example and without limitation, an Indium Gallium Arsenide detector; a lead sulphide detector, or a mercury-cadmium-telluride detector.

Spatial information of a sample may be obtained in addition to spectral information by employing “hyperspectral imaging” (also sometimes referred to as “chemical imaging” or “spectroscopic imaging”), an advanced analytical technique that combines conventional digital imaging and the physics of NIR spectroscopy. See, e.g., Koehler IV et al. (2002) Spect. Eur. 14:12-9; Burger and Geladi (2006) Analyst 131:1152-60; Gowen et al. (2007) Trends Food Sci. Technol. 18:590-8. Hyperspectral imaging has emerged as a powerful analytical tool in agriculture. Kazemi et al. (2005) CIGR J. VII:1-12; Fernández Pierna et al. (2006) Chemometrics Intel. Lab. Systems 84:114-8; Gorretta et al. (2006) J. Near Infrared Spectrosc. 14:231-9; Weinstock et al. (2006) Appl. Spec. 60:9-16; Baeten et al. (2007) “Hyperspectral imaging techniques: an attractive solution for the analysis of biological and agricultural materials,” In: Techniques and applications of hyperspectral image analysis, Grahn & Geladi, Eds., Chichester, England: John Wiley & Sons, Ltd., pp. 289-311; Mahesh et al. (2008) Biosys. Eng. 101:50-7; Shahin and Symons (2008) NIR News 19:16-8.

Hyperspectral images are commonly known as hypercubes. Hypercubes are a three-dimensional block of data, defined by two-dimensional images composed of pixels in the x and y direction, and a wavelength dimension in the z direction. Hypercubes consist of hundreds of adjacent wavebands for each spatial position of a sample. Each pixel in a hyperspectral image consists of a complete NIR spectrum for that specific position of the sample, and thereby provides a fingerprint for that position. Hyperspectral images may be acquired by several imaging configurations that may be available in particular NIRS installations, for example, point scan, focal plane scan, and line scan imaging configurations.

In some embodiments, a system of the invention may be configured to acquire hyperspectral images of a sample from which spatial information is to be obtained, and may comprise analytical programming for utilizing a plurality of chemometric models to determine a relationship between the NIRS data and a characteristic of the sample at the position defined by a pixel in the hyperspectral image.

### V. Methods for Determining a More Accurate Chemometric Model for NIRS Data Analysis, and Utilizing Such Models to Characterize a Plant Sample

### Plant Samples and Data Collection

In some embodiments, a method according to the invention comprises a plant sample, wherein the plant sample may be scanned by a NIRS imaging instrument to acquire NIRS data. Any plant sample able to be scanned by such an instrument may be used in methods according to some embodiments. For example and without limitation, solid samples, granular samples, and/or liquid samples may be analyzed in particular embodiments. Certain examples relate to the analysis of plant seed samples. In these embodiments, a plant sample may comprise a whole seed, ground seed material, or parts of a seed (e.g., endosperm, embryo, etc.).

NIRS data may be collected by scanning a plant sample with a NIRS imaging instrument over a range of wavelengths in the NIR range. For example, in particular embodiments, a sample may be scanned over the range of from about 650 nm to about 2500 nm. A scanning procedure may be repeated for a single sample in order to measure average absorbances. In particular embodiments, between about 5 and 50 scans may be averaged (e.g., 5, 6, 7, 8, 9, 10, 12, 14, 16, 18, 20, 22, 24, 26, 28, 30, 35, 40, 45, or 50 scans). The average absorbances thus collected may form the NIRS data that is then analyzed to determine a chemometric model that more accurately predicts or identifies a particular characteristic of interest in the scanned plant sample. To ensure that the instrument performance is consistent through the entire data acquisition process, an internal standard may be scanned before, during, and after the scan of the sample.

### Multivariate Data Analysis Using Chemometric Models

Embodiments of the invention utilize a plurality of chemometric models to perform multivariate analysis of NIRS data, so as to select a model that more accurately predicts or identifies a characteristic of interest in a plant sample. In general, multivariate data analysis involves the extraction of information from a data matrix. Depending on the type of analysis to be performed (e.g., data exploration, supervised classification, unsupervised classification, and curve resolution) and the characteristic and sample type to be analyzed, different chemometric models give significantly different results. One model that is not suitable for classification of a particular sample type with respect to a particular characteristic may be the most-suitable model for a different analysis under different circumstances, and there is generally no way for a practitioner to know, a priori, which of several models will yield the best results. General information regarding multivariate analysis using chemometric models (including artificial neural networks) may be found, for example, in Massart and Kaufman (1983) The Interpretation of Analytical Chemical Data by the Use of Cluster Analysis, New York, N.Y.: Wiley. Varmuza (1980) Pattern Recognition in Chemistry, Berlin, Germany: Springer.

### Pretreatment

Signal processing may be used to transform spectral data prior to calibration, which processing is sometimes referred to as data “pretreatment.” See, e.g., Brereton (1990) “Pattern recognition,” In: Chemometrics: Applications of Mathematics and Statistics to Laboratory Systems, Chichester, West Sussex, England: Ellis Horwood Ltd., pp. 239-95; Bro and Heimdal (1996) Chemometrics Int. Lab. Sys. 34:85-102. Pretreatment methods may increase the signal-to-noise ratio in NIRS data by reducing noise in a spectrum, for example, by reducing random noise, reducing baseline effects, and/or reducing spectral interferences. Beebe et al. (1998), supra; Heise & Winzen (2002), supra. Sources of noise in NIRS data may include, for example and without limitation, the interaction of compounds, light scattering effects, optical path length variations, and/or spectral distortions caused by instrument hardware.

Thus, pretreatment methods may be employed in some embodiments to reduce, eliminate, or standardize signal to noise problems in NIRS data without significantly reducing the spectroscopic information. Pretreatment methods commonly used include, for example and without limitation, standardizing, normalization, sample weighting, smoothing, local filters, Savitzky-Golay smoothing, Fourier filtering, derivatives, baseline correction methods, multiplicative scatter correction (MSC), standard normal variate (SNV), orthogonal signal correction (OSC), mean centering and variable weighting. Beebe et al. (1998), supra; Heise and Winzen (2002), supra; Feudale et al. (2002) Chemometrics Int. Lab. Sys. 84:114-8; Nicolaï et al. (2007), supra. In order to apply a pretreatment method to NIRS data, optimization and pretreatment parameters are selected and provided according to the discretion of the practitioner.

After one or more pretreatment methods have been employed to increase the signal-to-noise ratio in NIRS data, regression and calibration techniques may be applied to the data. Regression techniques, for example, may be necessary to extract information comprised within overtones and combination bands of NIR spectra, and/or to extract information captured in a hypercube.

### Multivariate Matrix Analysis

One of many suitable eigenvector-based multivariate chemometric analyses may be used in some embodiments to analyze a matrix of NIRS data from a plant sample. In particular examples, any suitable multivariate chemometric analysis technique may be used to extract useful information from a NIRS data matrix of size I×K, where I are the objects and K are the variables. In particular examples, an “object” may be an individual plant sample, and “variables” may be the absorbance of the sample at an NIR wavelength.

Chemometric analyses typically utilize linear algebra, according to the following notation:
x, y are scalar values;
x, y are column vectors;
X, Y are matrices;
X′ is the transpose of x, and thus a row vector;
X⁻¹ is the inverse of a matrix;
X⁺ is a generalized inverse;
X and Y are three-way arrays; and
the indices are i=1, . . . , I; j=1, . . . , J; and k=1, . . . , K, for the arrays, and a=1, . . . , A for the number of components.

Although a number of multivariate chemometric analyses are available to those of skill in the art, and embodiments of the invention utilize a plurality of such analyses (e.g., to select a more accurate analysis method), the particular technique of principal component analysis (PCA) is described in detail herein, in order to exemplify certain features of particular embodiments. It will of course be understood that by describing PCA particularly, the invention is not limited to the use of PCA or to embodiments which include PCA. But rather, for the sake of brevity in view of the scope necessary to explain all multivariate chemometric analyses that are known, PCA is described in detail only by way of example. Furthermore, for the purposes of this disclosure, a “means for performing multivariate chemometric analysis of NIRS data” refers to multivariate chemometric analyses/models that are known to those of skill in the art for reducing a data matrix into meaningful information.

In general, PCA transforms the object variables in a set of data to best explain the variance in the data. PCA employs orthogonal transformation to convert data regarding object variables that may be correlated into a set of values of uncorrelated variables, which are latent variables referred to in PCA as “principal components.” While useful, principal components do not correspond naturally to the chemical composition of a sample from which the data matrix was obtained. The number of principal components in the set is less than or equal to the number of original variables. The orthogonal transformation is such that the first principal component in the set has as high a variance as possible. Thus, the first principal component accounts for as much variability as possible in the original data. Each succeeding component generated by the transformation has the highest variance possible, though it must satisfy the constraint that that the succeeding component is orthogonal to all preceding components in the set. Therefore, each principal component represents an independent source of variation in the original data.

According to the foregoing, a multivariate dataset comprising a set of coordinates in a data space of 1 axis per variable may be transformed by using the first few principal components, so that the dimensionality of the transformed data is reduced to provide a lower-dimensional space of the multivariate dataset that may be more easily examined. In the equation:

X=t₁p₁′+t₂p₂′+ . . . +t_{A}p_{A}′+E (1)

where X is an (I×K) matrix, the tₐ are score values for the ath component, pₐ are loading values for the ath component, and E is the (I×K) residual matrix. PCA attempts to explain the sum of squares of X as much as possible, while using a minimum of principal components. To accomplish this, the t_{A} is made orthogonal and the p_{A} is made orthonormal:

tᵢ′tⱼ=0(i>j),pᵢ′pⱼ=0(i>j),pᵢ′pⱼ=1(i>j) (2)

The score values and loading values are used in line plots or scatter plots that allow an efficient interpretation of the whole data space, where the noise is largely left in the residual. A score plot for two principal components may comprise one or more of: a dense cluster of scores, a less dense cluster of scores, outlying scores, and a gradient between clusters of scores. Dense clusters denote smaller variation, while less dense clusters denote larger variation. Pure classes of dense and less dense clusters may exist, but often have a gradient between them. Outliers are also identified and may be explained. Possible sources of outlying data include, for example and without limitation, sampling errors, analysis error, errors in data handling, and number rounding. Alternatively, outliers may be based on the genuine existence of an unknown class of objects.

Various combinations of principal components are typically plotted against each other in a score plot and inspected for clusters of scores. By studying the score plots, it can be determined which components contribute mostly to distinctly separating the clusters. Knowledge of the number of distinct species in your sample may indicate an expected number of clusters. For example, if seed material from two types of seed with distinct oleic acid contents is analyzed, two clusters would be expected to be apparent in the score plot.

Data are often transformed by any of a variety of available methods before an analysis is attempted. Individual linear, logarithmic, or exponential scaling of variables may be used in some examples. A particular scaling method that is best for one data set will not be the most suitable for another data set. Thus, the scaling method must be determined for each data set to be analyzed, usually by time-consuming trial and error.

### Chemometric Calibration Models

In embodiments, a database of chemometric calibration models may be provided, and a best model of the database may be selected from analyses of spectroscopic data to determine one or more properties of interest in a plant sample. For example, a property of interest may be a property that is related to a trait of interest in the plant species from which the sample was obtained.

Calibration is used in the chemometric solution of many problems in analytical chemistry and biology. Calibration is used to develop a model that predicts a property of interest from measured attributes of the chemical system, such as NIR absorbances. Many multivariate calibration analyses have been used independently in combination with spectral data. For more detailed information regarding the use of particular multivariate calibration models, see, e.g., Martens and Naecs (1989) Multivariate Calibration, Chichester, U.K.: Wiley; Beebe et al. (1998) Chemometrics: a Practical Guide, supra; Brown (1993) Measurement, Regression and Calibration, Oxford, U.K.: Clarendon Press; Martens and Martens (2000) Multivariate Analysis of Quality, an Introduction, Chichester, U.K.: Wiley; Naes et al. (2002) A User-friendly Guide to Multivariate Calibration and Classification, Chichester, U.K.: NIR Publications.

Calibration requires a training data set, which includes reference values for the property of interest and the measured attributes believed to correspond to the property. For example, training data may be acquired from a number of reference samples, including known concentrations for an analyte of interest and the corresponding NIR spectrum of each sample. One of many multivariate calibration techniques known to those of skill in the art (e.g., partial-least squares regression, principal component regression, etc.) are then used to construct a chemometric calibration model that relates a set of measured attributes (e.g., NIRS data) to, for example, a concentration of an analyte of interest in a sample. The resulting chemometric calibration model may subsequently be used to efficiently predict concentrations of the analyte in new samples. The model may be improved by “learning,” as new data is collected and added to the training reference set.

Multivariate calibration techniques may allow a sample property to be determined quickly, cheaply, and non-destructively, even from very complex samples containing many other properties (e.g., similar chemical species). The selectivity of the modeling process is provided as much by the mathematical calibration as the analytical measurement modalities. For example, NIR spectrometry is extremely broad and non-selective compared to other analytical techniques (such as IR and Raman spectrometry). Yet in some embodiments, the use of selected multivariate calibration models to analyze NIRS data from a complex plant sample provides a very good determination (e.g., identification, classification, and quantitative measurement) of chemical species or properties (e.g., moisture, hardness, etc.) in the sample.

The calibration of a chemometric model for analyzing spectroscopic data involves building a regression relationship between a desired chemical, biological, or physical property of a sample and its spectrum. The regression relationship is:

y=ƒ(x) (3)

where y is the desired concentration (or other property) in a sample, and the vector x is a spectrum. Thus from the function ƒ, the concentration may be calculated from the measured spectrum of a particular sample. In some embodiments of the invention, multivariate calibration may involve one or more of: finding the function ƒ; selecting calibration standards for finding ƒ; producing diagnostics for the quality of ƒ; using ƒ to determine unknown concentrations/properties from spectra; and diagnostic testing of this determination.

Determining exact relationships of the form y=ƒ(x) is complicated by noise in the data. Therefore, the regression relation is often expressed in linear form:

y=Xb+f (4)

where y is a vector of measured responses for I objects; X is a (I×K) matrix of measured spectra for the I objects; b is a vector of regression coefficients; and f is a vector of residuals (not to be confused with the function ƒ). Eq. (3) represents the hard model, where the equation f has to be known in advance, or determined exactly. Eq. (4) is a soft equation, where some functioning values of b have to be found without much background knowledge of the system.

In chemometrics, where often more variables than objects are available, the calculation of b may be performed by any of many latent variable methods known to those of skill in the art (e.g., principal component regression (PCR); partial least squares regression (PLS) regression; machine learning techniques, artificial neural networks (ANN) and support vector machines (SVM); etc.). See, e.g., Karjalainen and Karjalainen (1996) Data Analysis for Hyphenated Techniques, Amsterdam, The Netherlands: Elsevier. Accordingly,

y=Tq+f (5)

where T is a matrix of latent variables (for example, principal components from PCA) and q comprises the regression coefficients for the columns in T.
Eqs. (4) and (5) have standard solutions for b of the type:

b=(X′X)⁻¹X′y (6)

and

b=(T′T)⁻¹T′y, (7)

or by defining a generalized inverse X⁻¹:

b=X⁻¹y (8)

A number of methods are known in the art for modifying Eqs. (6)-(8) to improve the calculation of b. These methods include, for example and without limitation: ordinary least squares (OLS)/multiple linear regression (MLR) (Draper and Smith (1981) Applied Regression Analysis, 2^{nd} Ed., New York, U.S.A.: Wiley); ridge regression (RR) (Hoerl and Kennard (1970) Technometrics 8:27-51); principal component regression (PCR) (Massy (1965) J. Am. Stat. Assoc. 60:234-56); latent root regression (LRR) (Webster et al. (1974) Technometrics 16:513-22); partial least squares regression (PLS) (Helland (1988) Commun. Stat. B, Simulations Comput. 17:581-607; Höskuldsson (1988) J. Chemometrics 2:211-28); sliced inverse regression (SIR) (Li (1991) J. Am. Stat. Assoc. 86:316-42); continuum regression (CR) (Stone and Brooks (1990) J. Royal Stat. Soc. B 52:237-69); locally weighted regression (LWR) (Naecs and Isaksson (1989) Appl. Spectrosc. 43:328-35); and principal covariates regression (PCovR) (de Jong and Kiers (1992) Chemometrics Intelligent Lab. Syst. 14:155-64).

The models in Eqs. (4) and (5) are linear. However, the relationship between the regression coefficients and the measurements may be non-linear. There are a number of ways of improving the models for nonlinear relationships, any of which may be used in some embodiments of the invention. Models for nonlinear relationships may be improved, for example, through transformations of X and/or y (Geladi and Dabakk (1995) J. NIR Spectrosc. 3:119-32; Geladi (2001) Chemometrics Intelligent Lab. Syst. 60:211-24), or by modifying the models to account for particular spectroscopic knowledge (Barnes et al. (1989) Appl. Spectrosc. 43:772-7; Svensson et al. (2002) J. Chemometrics 16:176-88).

Currently, the chemometric analysis methodologies are restricted to those available through Unity, GRAMS and MATLAB toolboxes, restricting the methodologies used as well as the speed of the analyses. Based on extensive literature review, four algorithms most commonly used for NIRS analysis were identified as Principal Component Regression (PCR), Partial Least Squares (PLS) regression, and machine learning techniques Artificial Neural Networks (ANN) and Support Vector Machines (SVM). MATLAB algorithms for PLS (Cao (2008) Partial Least-Squares and Discriminant Analysis (available with tutorial on the internet at www.mathworks.com/matlabcentral/fileexchange/18760-partial-least-squares-and-discriminant-analysis)) and ANN (Artificial Neural Networks: ANN DTU MATLAB toolbox (available on the internet at bsp.teithe.gr/members/downloads/DTUToolbox.html)) were obtained as Mathworks packages. MATLAB code for LIBSVM, a powerful SVM implementation, was also obtained. Chang and Lin (2001) LIBSVM: a library for support vector machines (available on the internet at www.csie.ntu.edu.tw/˜cjlin/libsvm). The MATLAB code for PCR was developed in-house.

### Calibration Transfer

In some embodiments, methods of the invention include the chemometric determination of characteristics of a sample in a manner that is independent of the instrument, and/or instrument-type, upon which NIRS data was collected. In particular embodiments, a chemometric model is selected that provides more accurate determinations of a characteristic of interest on one instrument, and the model is subsequently transferred for analysis of NIRS data collected on another instrument without redevelopment of the model. In some embodiments, the capability of systems and methods of the invention to transfer calibration models allows data generated on different instruments to be pooled together into a single, more-robust training set for the development of a more optimal model. Information regarding the transfer of chemometric models may be found, for example, in Feam (2001) J. Near Infrared Spectrosc. 9:229-44.

### Outlier Detection

An important component of chemometric analyses is the detection of outliers in the data subjected to analysis, for example, the training data used to develop calibration models. As used herein, the term “outliers” refers to samples with anomalous spectral profiles or reference chemistry values. For example, the presence of contamination, degraded, or otherwise poor sample quality, and/or inconsistent sample preparation may result in outliers. In some embodiments, such outliers may be identified and removed from a training data set before model development, thereby providing that the model parameters are not affected by the presence of these anomalies. It will of course be noted that genuine variations in sample variety and characteristics are important to the development of an accurate and robust model. Therefore, these variations should be distinguished from outliers so that they may be identified and preserved during model development. In particular embodiments, at least one outlier detection technique(s) is included in a method of the invention. Useful outlier detection techniques include, for example: Mahalanobis distance; sample leverage; and graph theoretic measure (ODIN). These techniques may be implemented, for example, in MATLAB® code. In some examples, a voting procedure flags a sample as an outlier if two or more techniques categorize it as an outlier, and designates these samples for further review.

### VI. Use of Systems and Methods for NIR Spectral Analysis to Make Plant Selection and/or Breeding Decisions

Using a platform incorporating machine learning and statistics for NIR spectral analysis, as described hereinbefore, may provide for convenient and instant analysis of a range of chemical components and physical characteristics in a plant sample. According to some embodiments of the invention, measurement of NIR spectra for specific chemical screening may be exploited for chemical-physical characterization of whole plant samples or genotypes. For example, the identification and selection of a chemometric calibration model to perform analyses for a trait of interest of NIR data acquired from plant samples, and the superior analyses thus generated, may facilitate breeding decisions in a selective or directed breeding program.

In particular embodiments, a selected chemometric model may be utilized to generate from NIR data of a plant sample the selected model's determination of a trait or characteristic of interest within a range of possible determinations. Such a determination may subsequently be compared to determinations obtained from other samples, and one or more sample(s) may be identified that has a desirable trait or characteristic as determined by the selected model. The plant(s) from which the identified samples were obtained may be selected as comprising or likely comprising the trait or characteristic of interest, and may further be selected for propagation or breeding in order to produce inbred plants comprising the trait of interest, or to introgress the trait of interest into a germplasm.

The following examples are provided to illustrate certain particular features and/or embodiments. The examples should not be construed to limit the disclosure to the particular features or embodiments exemplified.

### EXAMPLES

### Example 1

### Use of an Automated Machine Learning and Statistics Platform to Analyze Characteristics of Canola Seed

### Materials and Methods

Canola seed samples were prepared from Natreon canola, or canola having the Yellow Seed Coat (YSC) trait. Training data was collected by scanning whole canola seed in a large spout cup on a SpectraStar™ 2500×NIR spectrometer (Unity Scientific, Inc.) over the 650-2500 nm wavelengths. Twenty-four scans at a counterclockwise step of four steps were averaged to obtain absorbance measurements. These scans were used to form the training NIR spectra. To ensure that the instrument performance was consistent through the entire process, an internal standard was scanned before, during, and after the scan of the training set.

### Calibration Models

PCR, PLS, ANN, and SVM chemometric calibration models were developed for NIR spectral analysis using the MATLAB® technical programming language. Cross-validation routines were developed, and each calibration model was verified to be robust and accurate in the NIR spectral range of interest for each seed compositional trait. The training data was then analyzed with each of the four chemometric calibration models that were developed, and the results of each analysis were compared for each seed compositional trait.

For each trait, the performance (R²) of each of the four calibration models was compared to find the model that was the most appropriate to capture the relationship between the spectra and the actual value of the trait. In each case, ten-fold cross-validation was used to determine a reliable estimate of regression accuracy, thereby ensuring that the accuracy observed during training was an unbiased estimate of regression accuracy for future test samples.

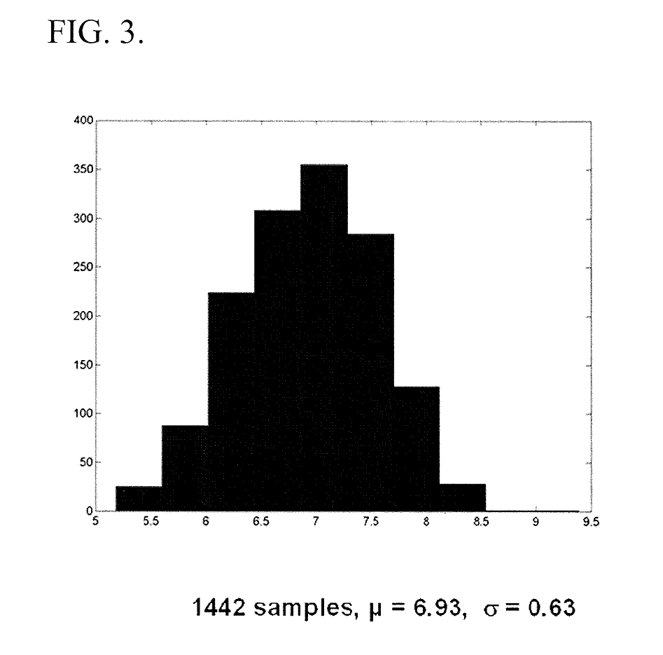

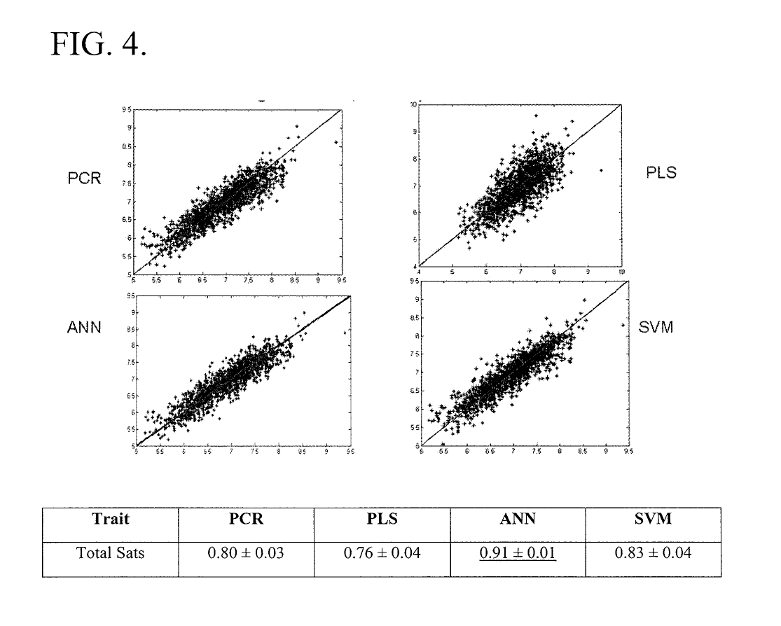

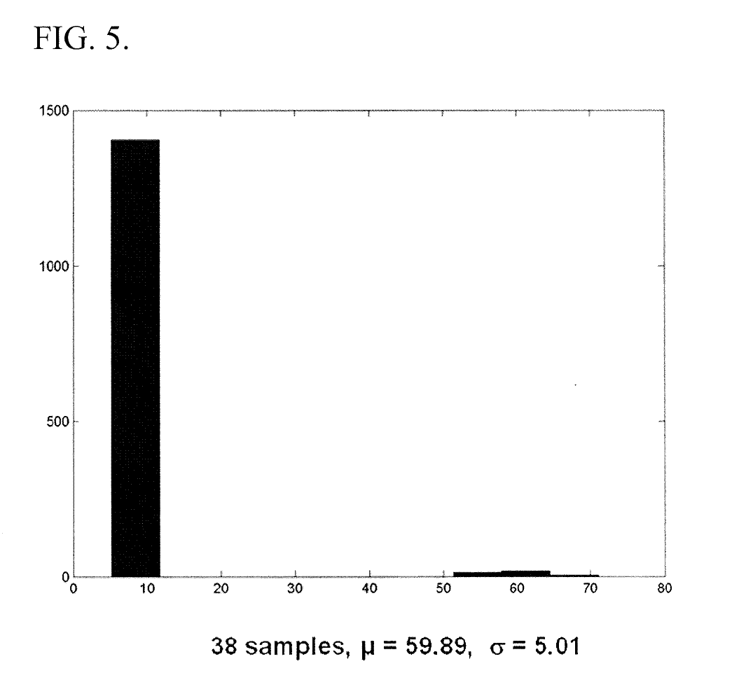

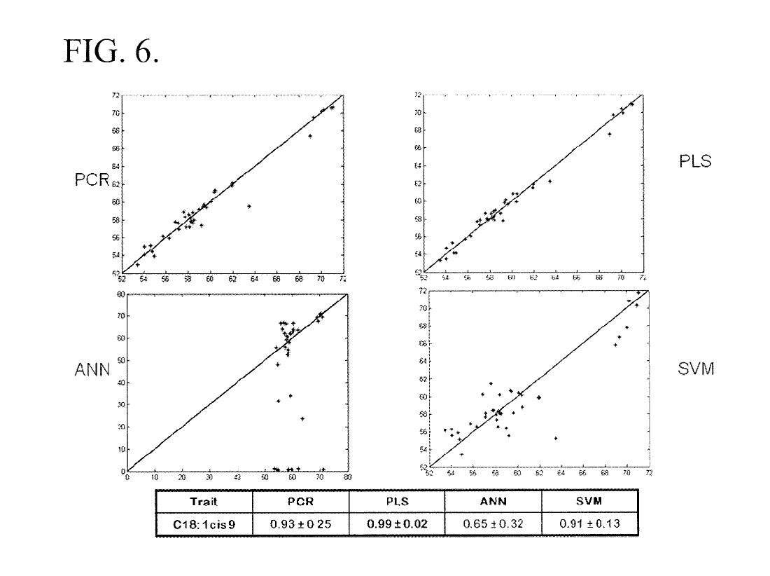

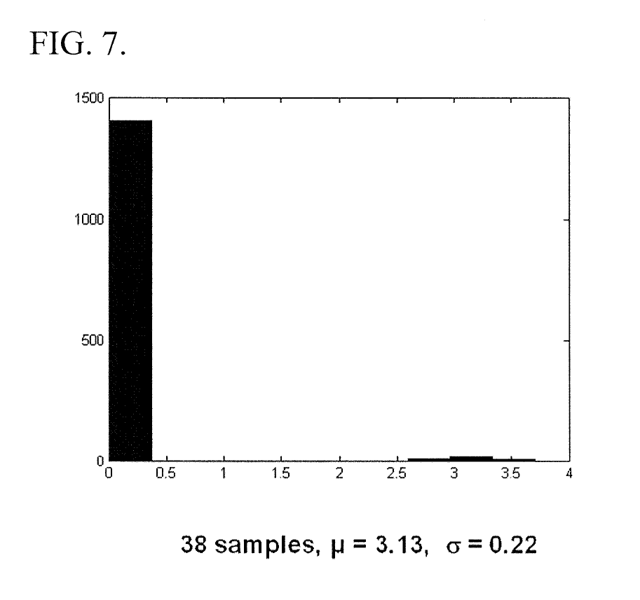

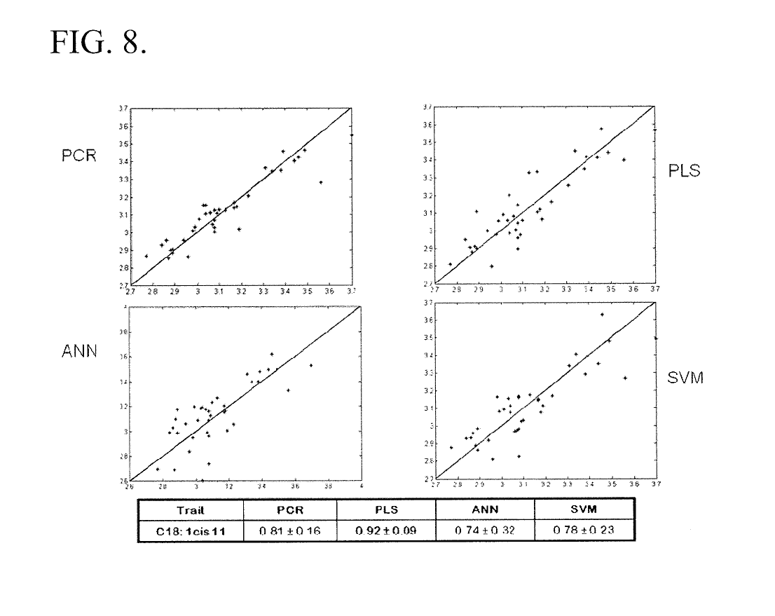

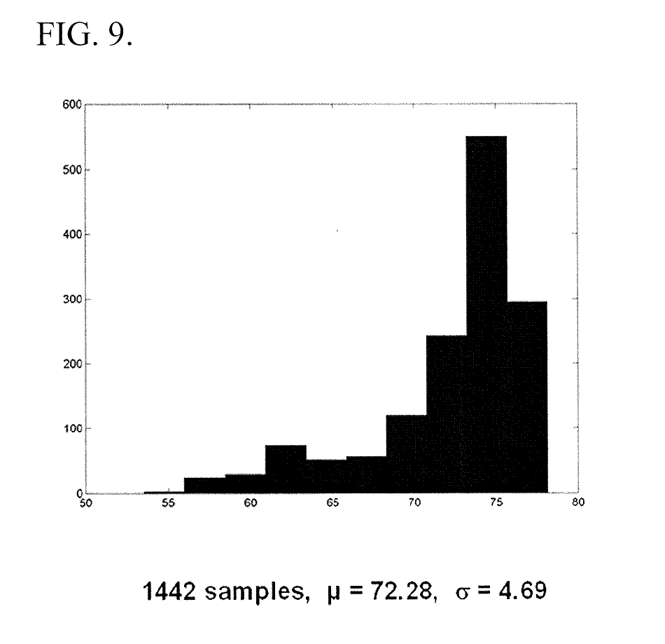

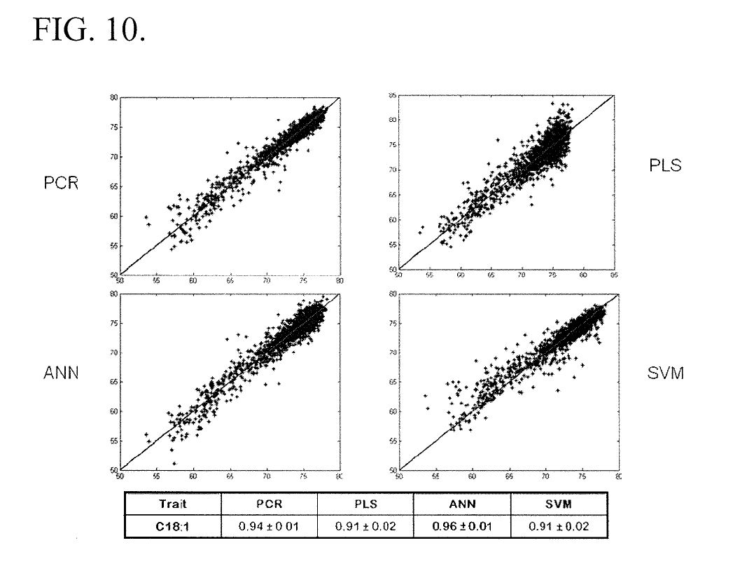

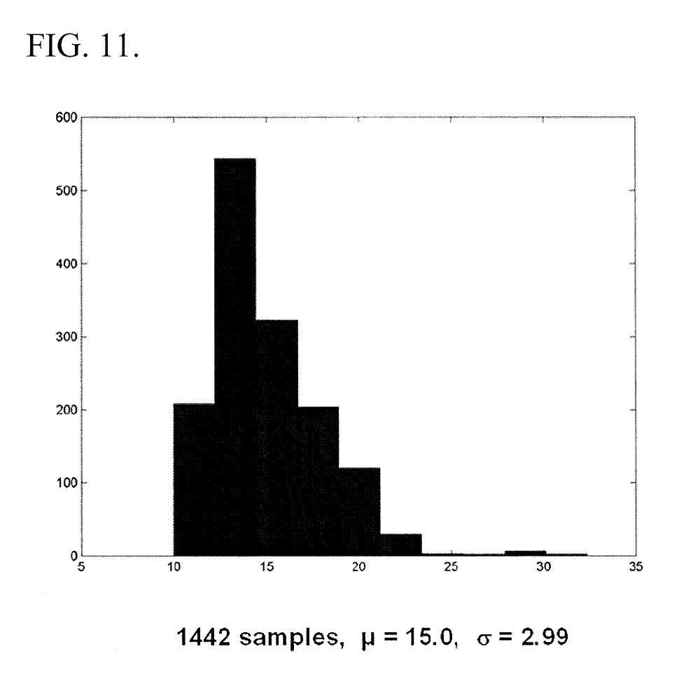

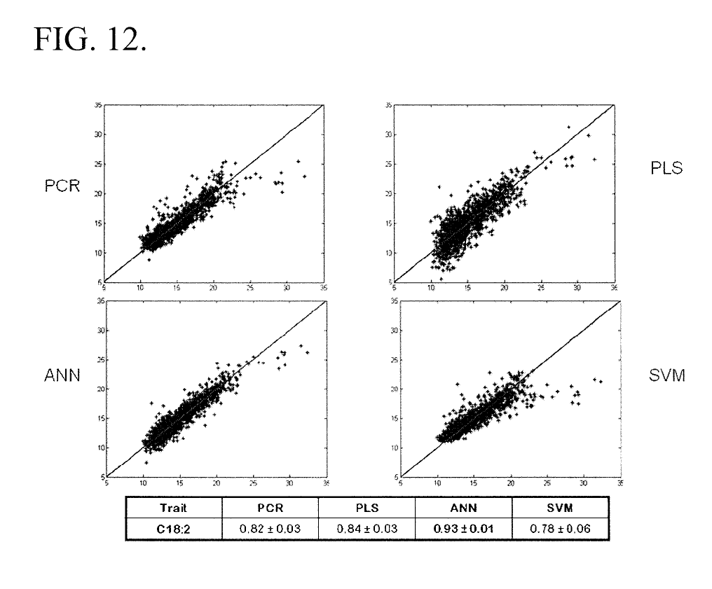

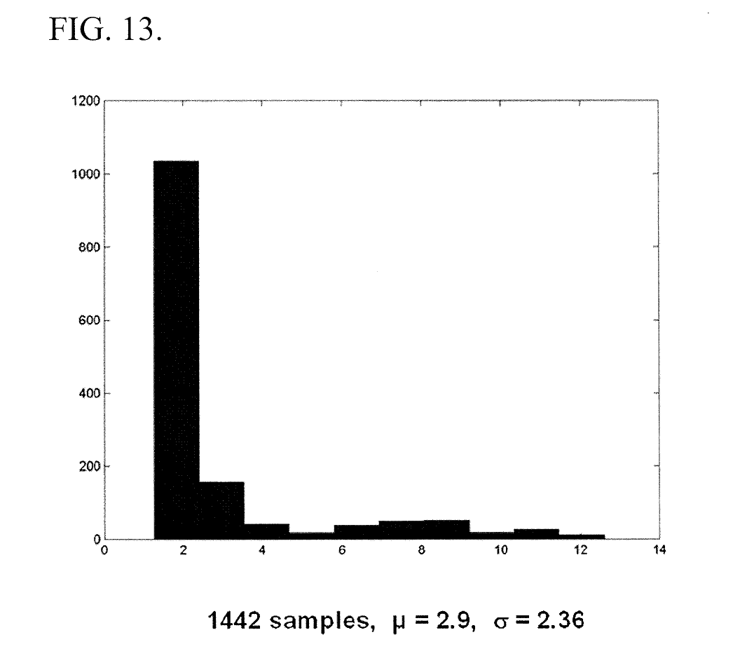

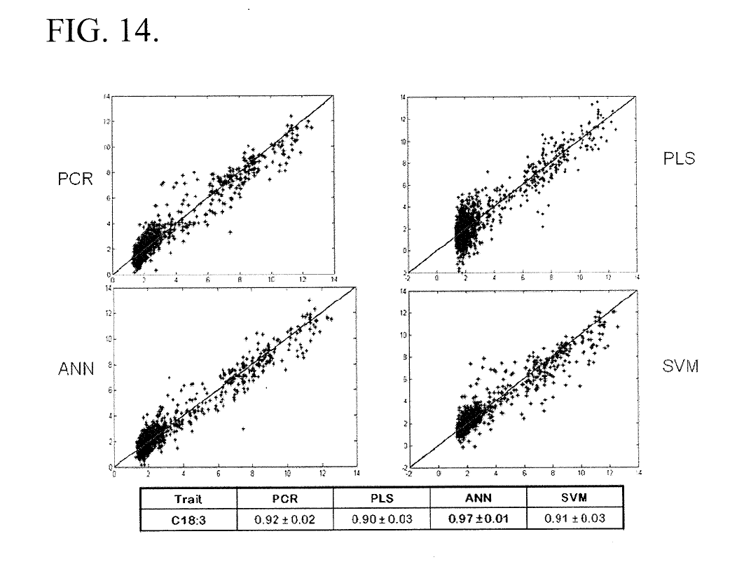

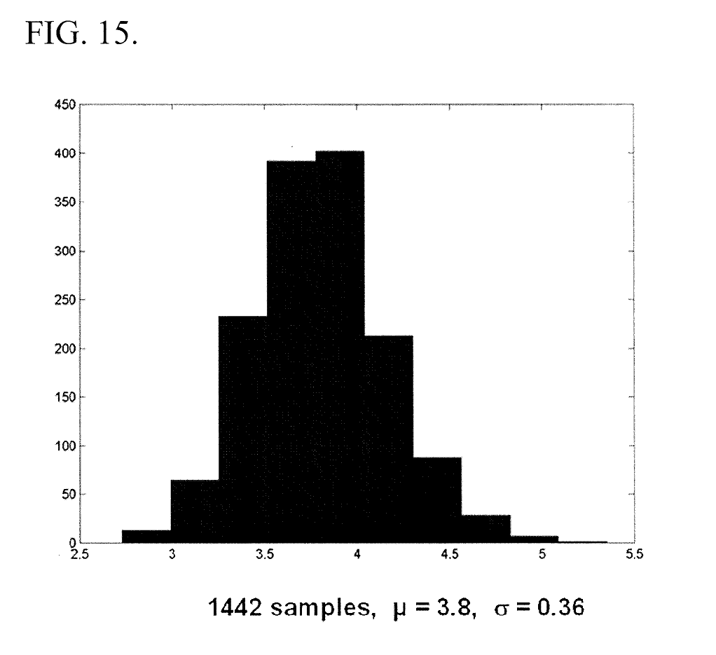

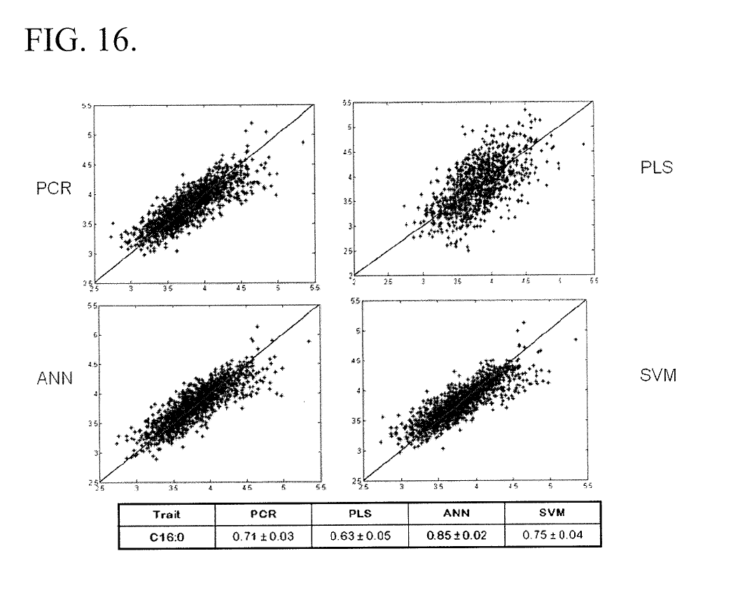

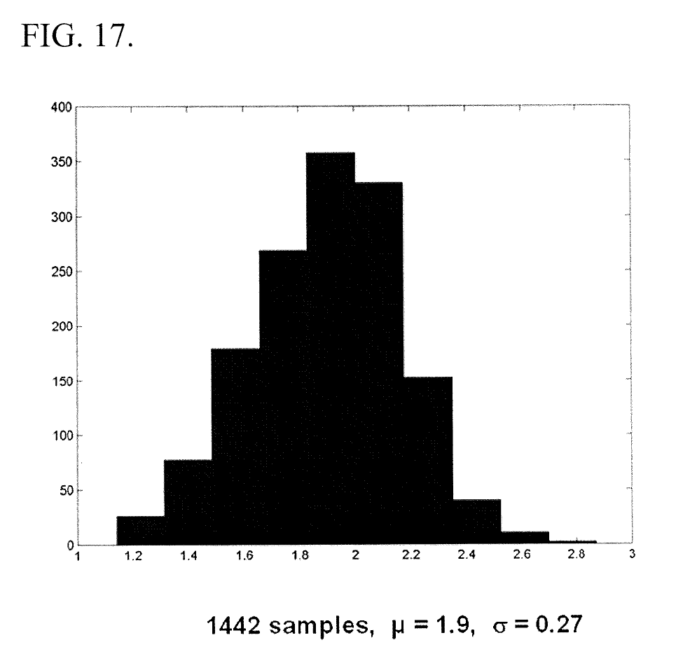

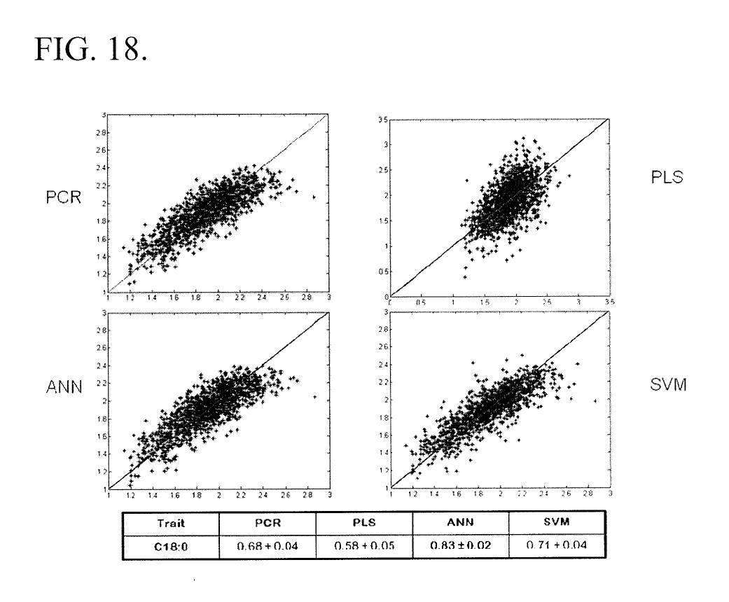

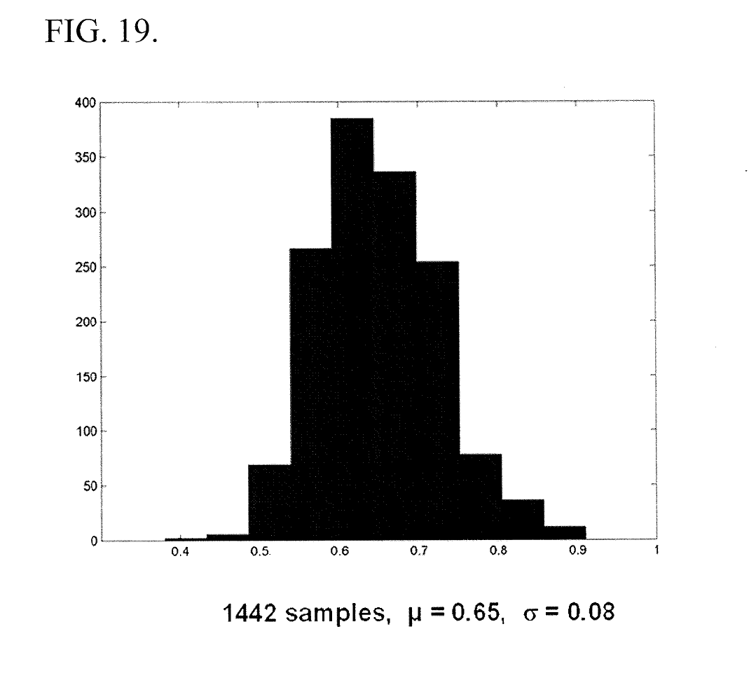

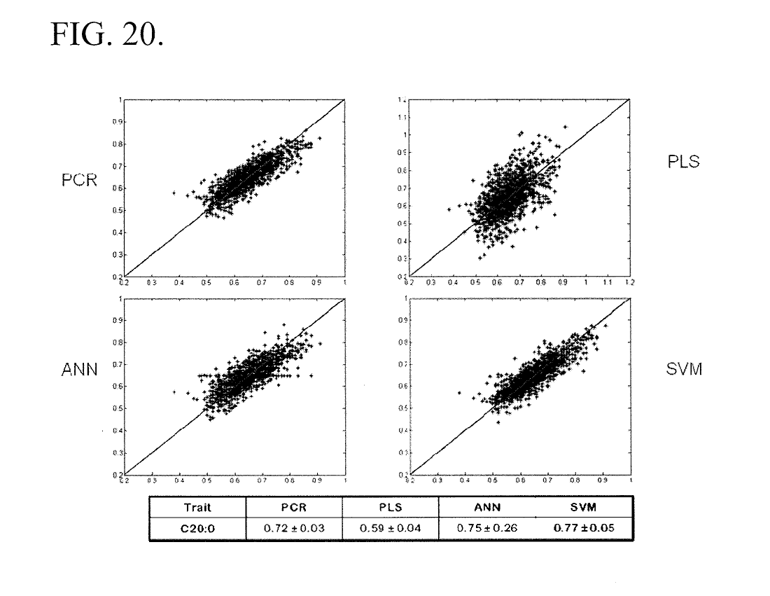

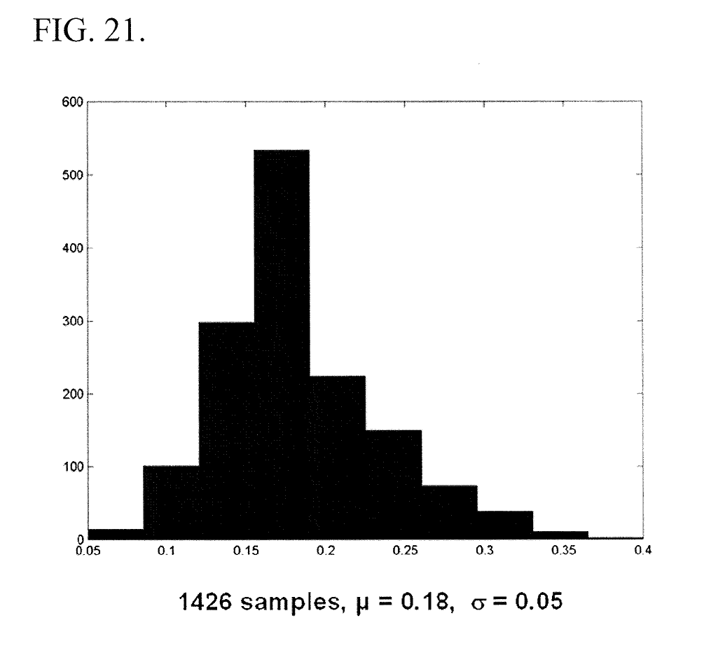

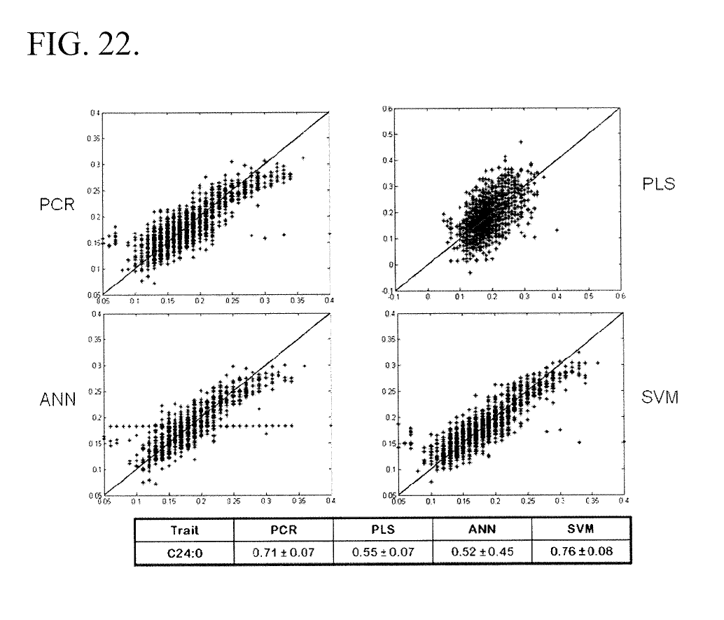

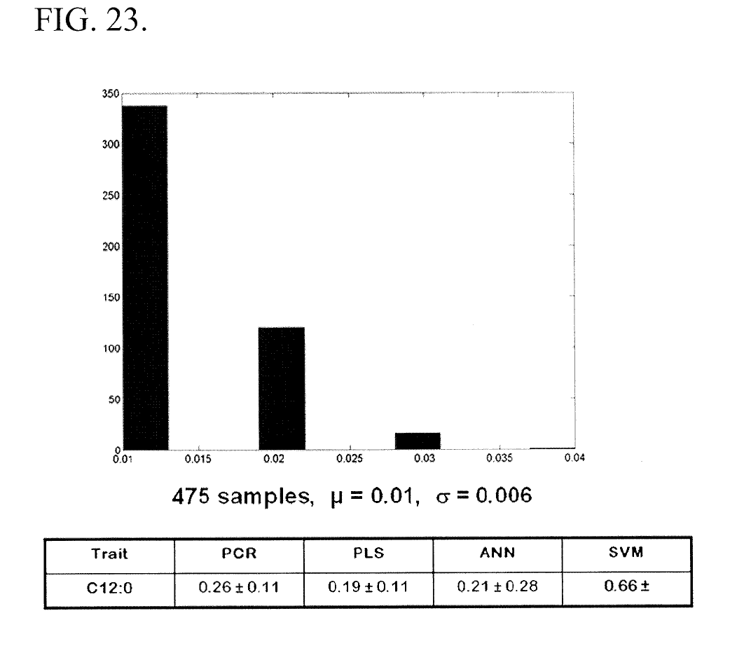

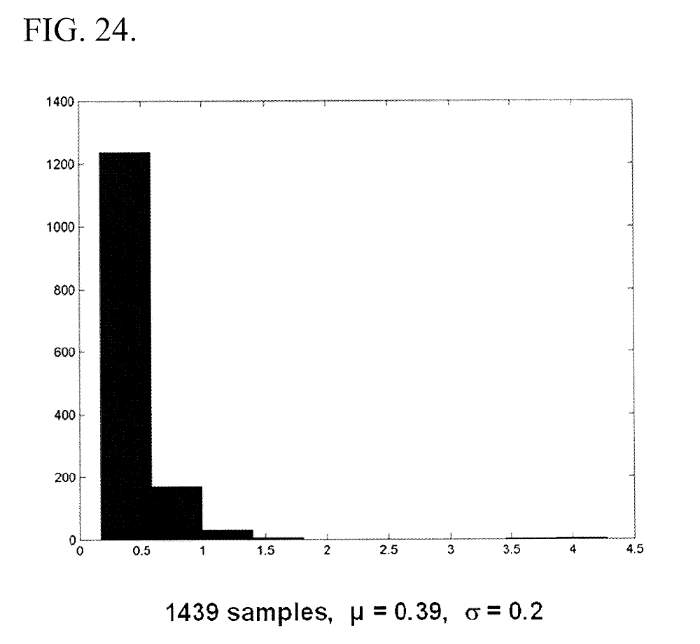

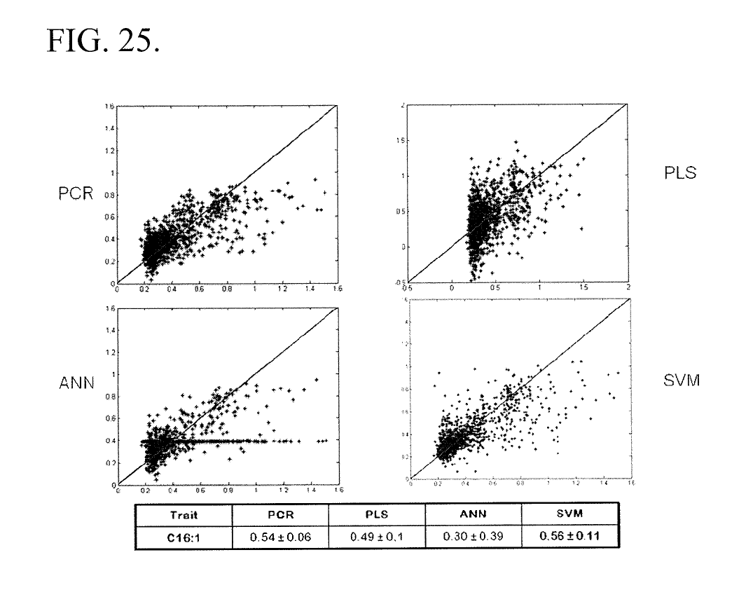

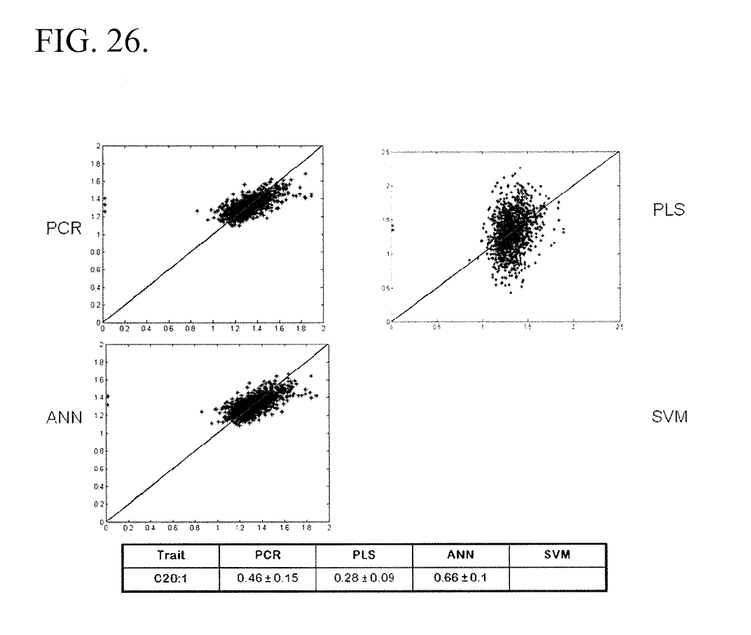

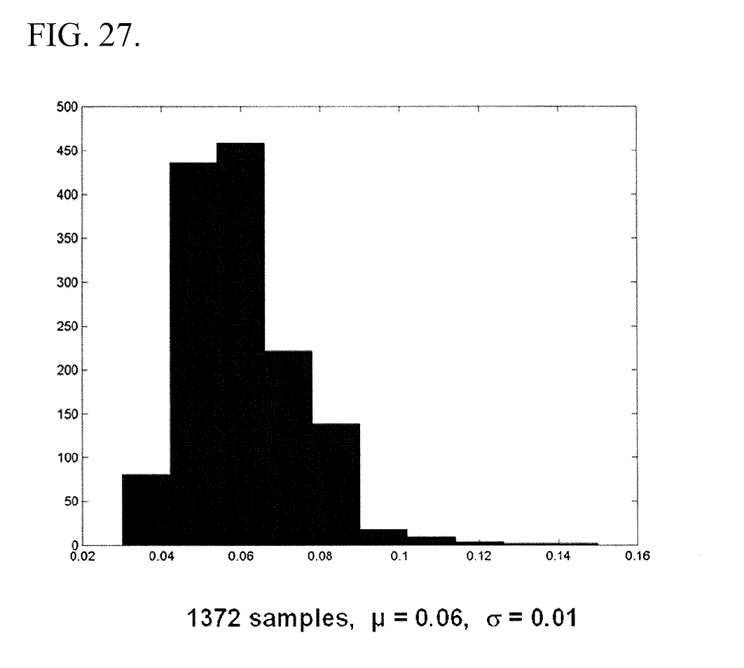

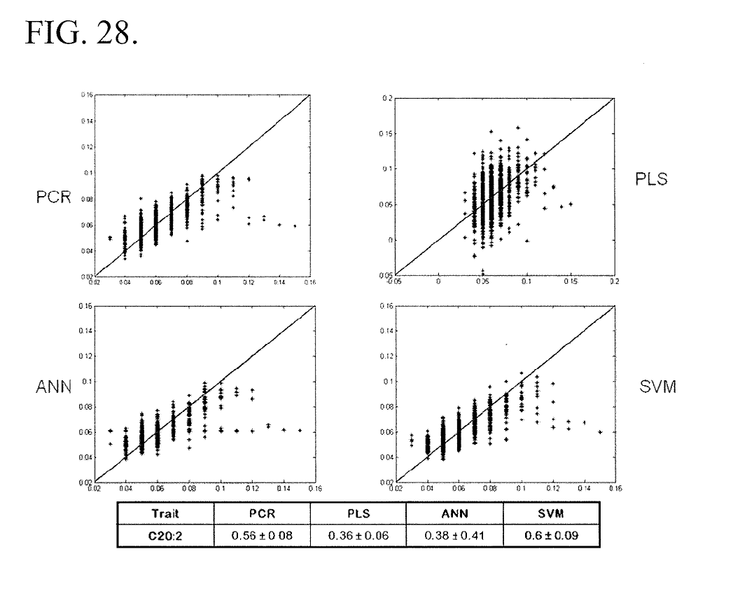

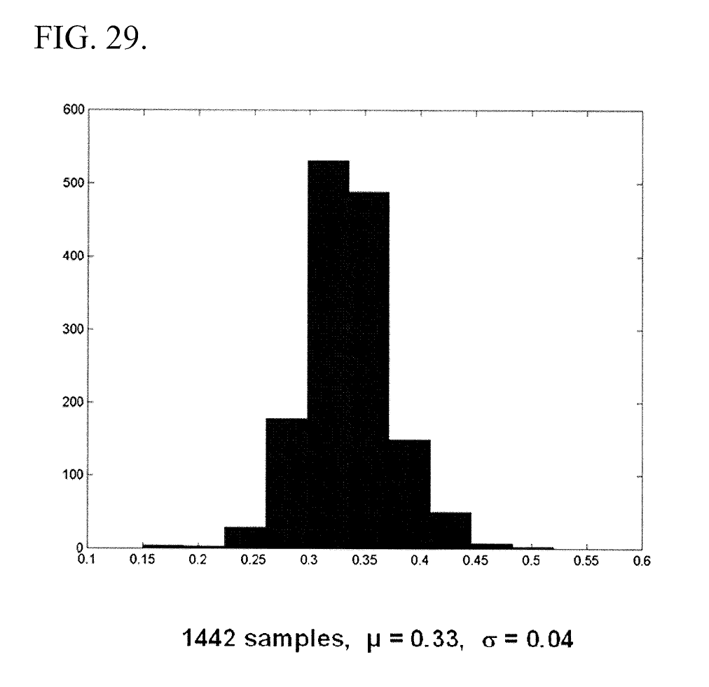

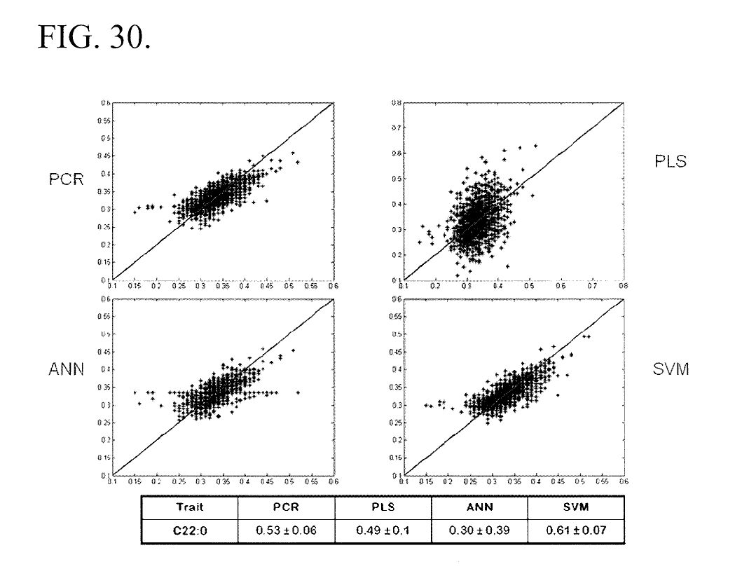

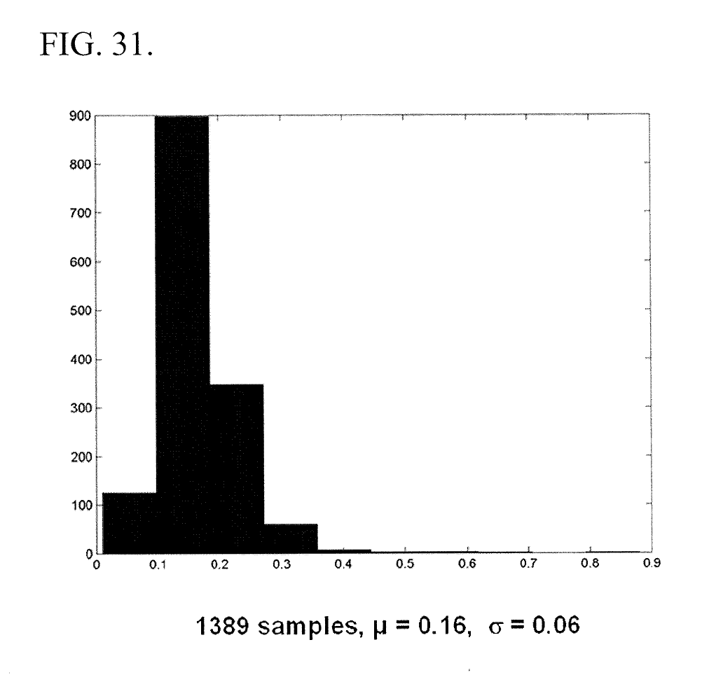

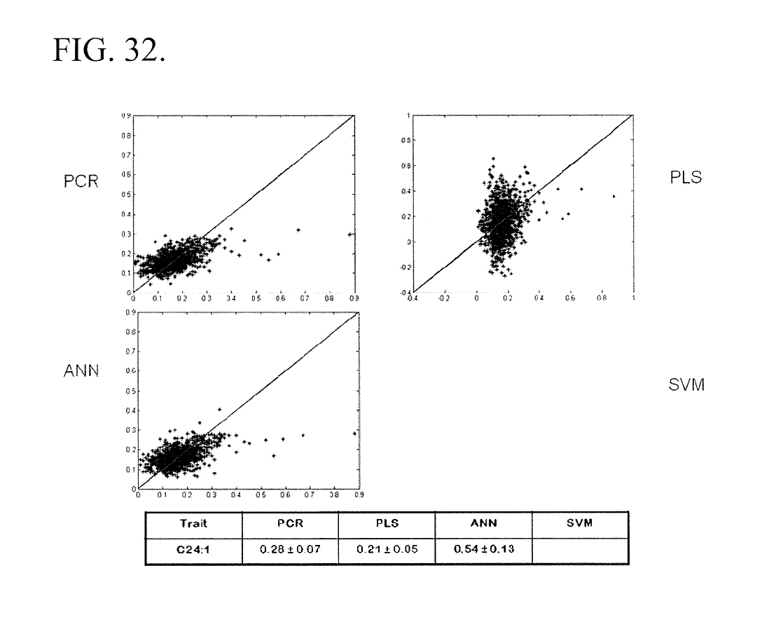

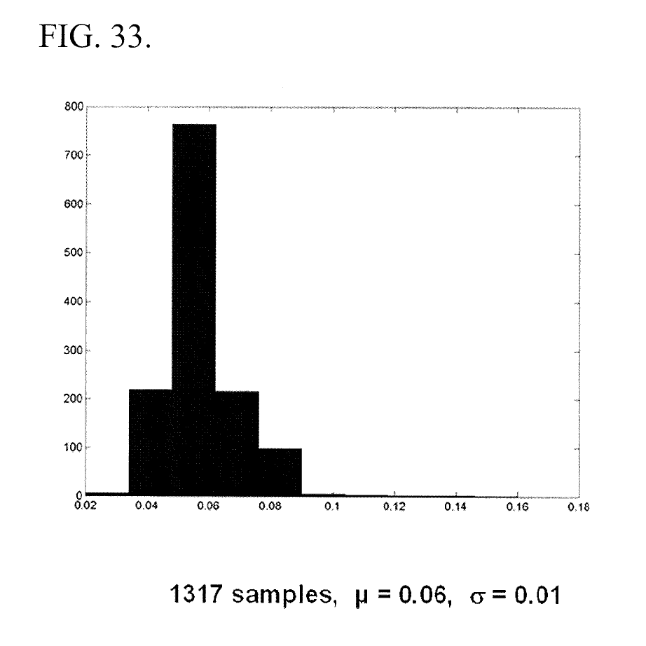

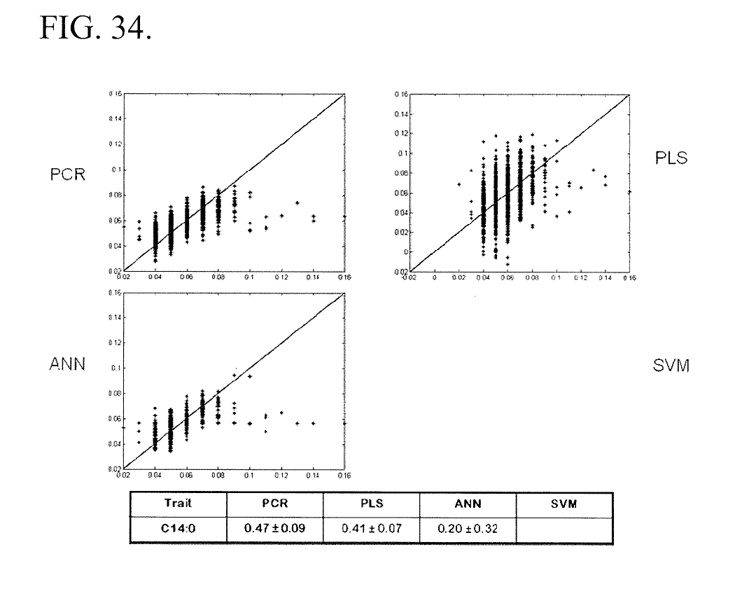

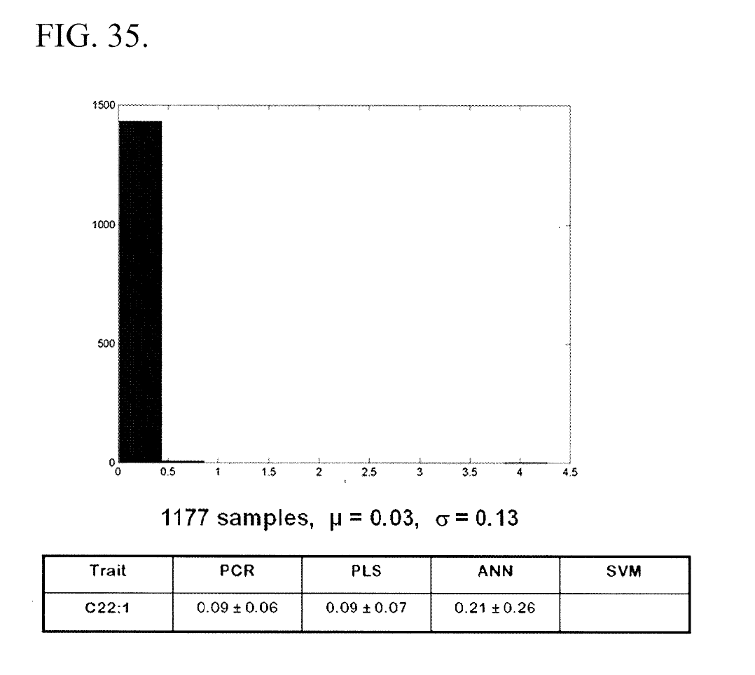

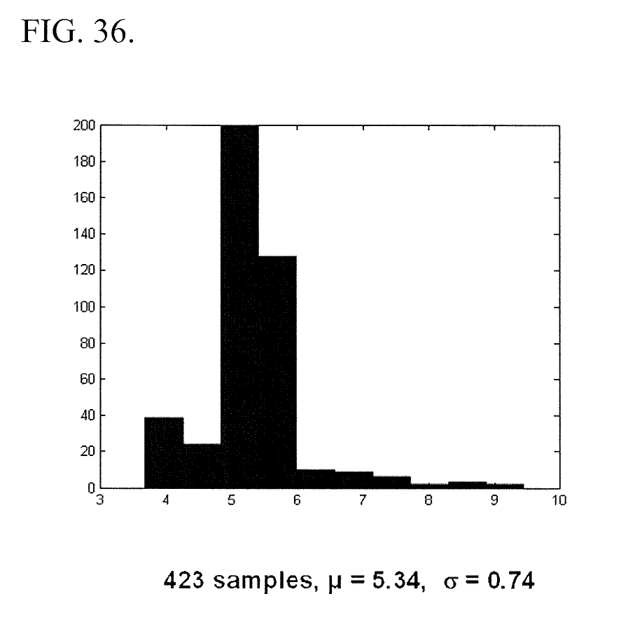

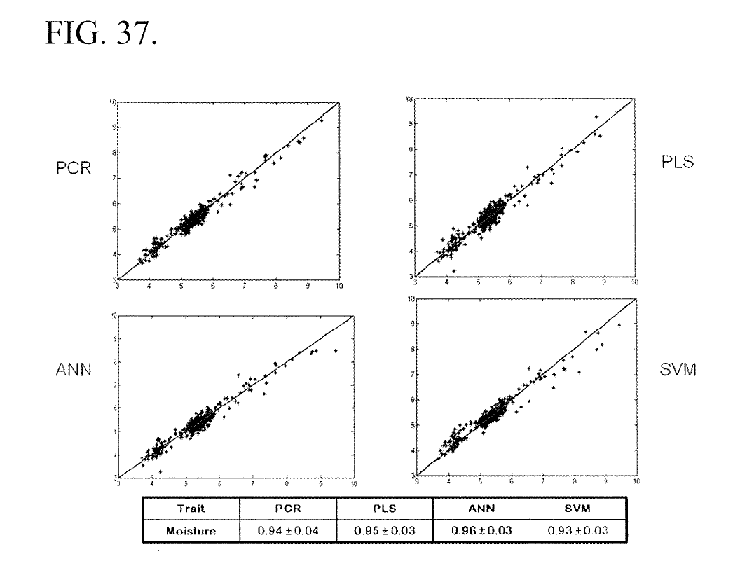

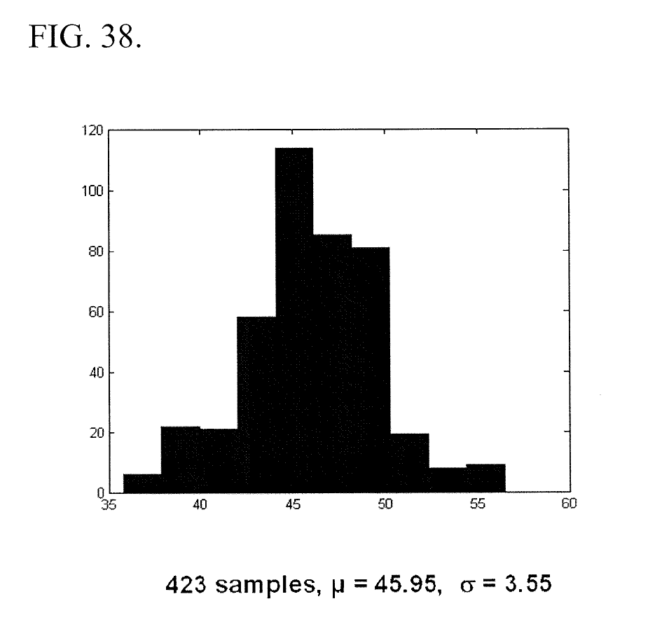

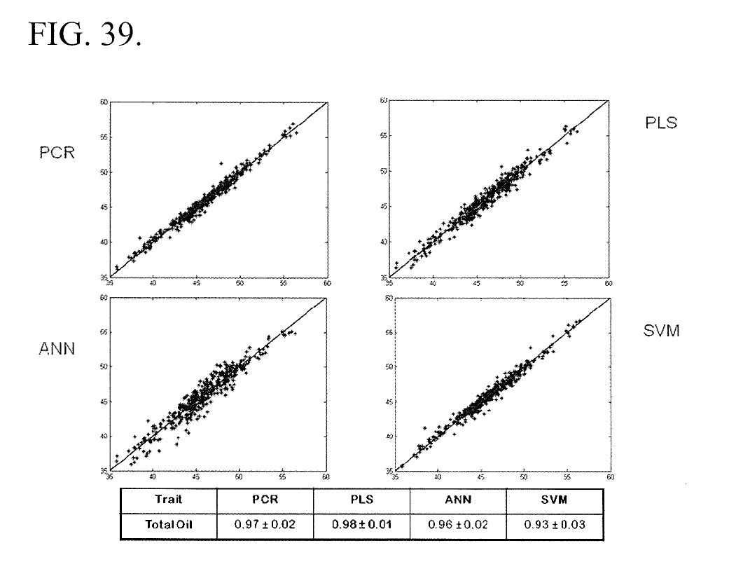

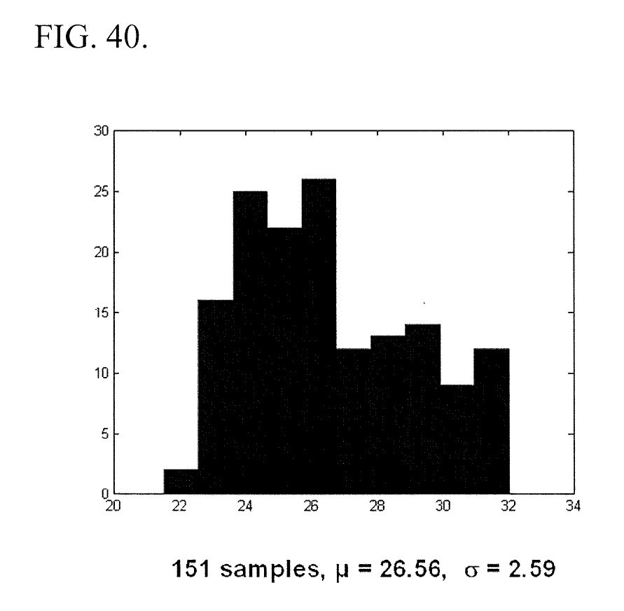

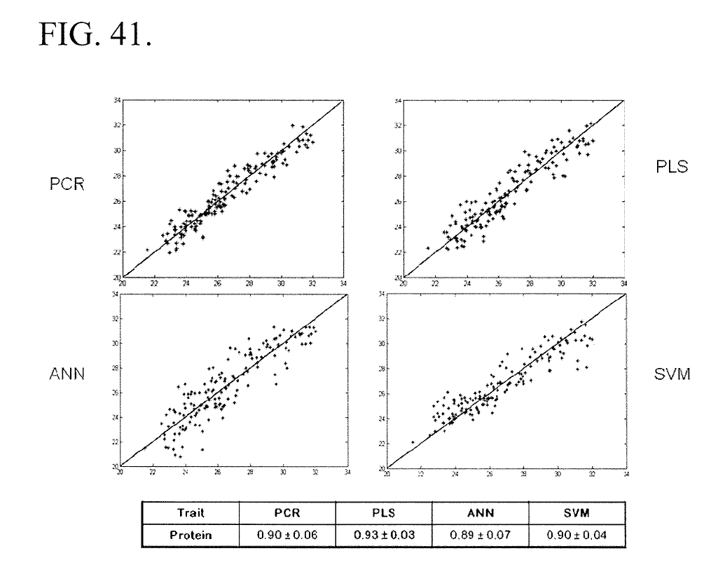

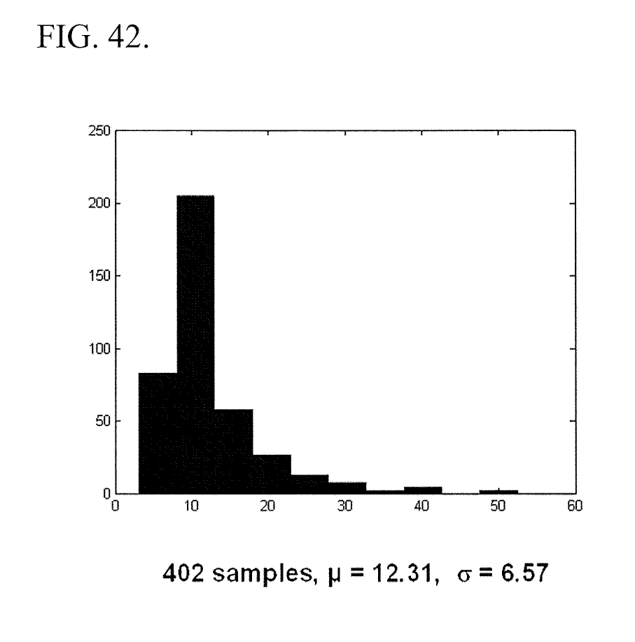

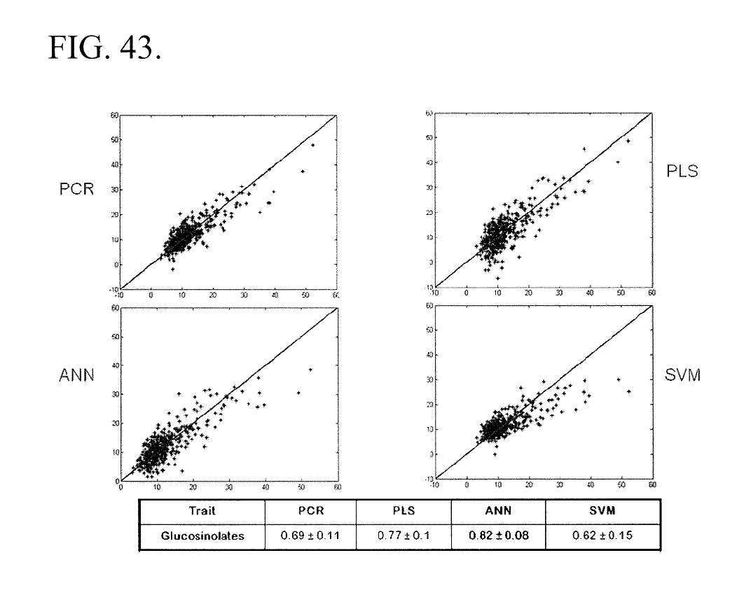

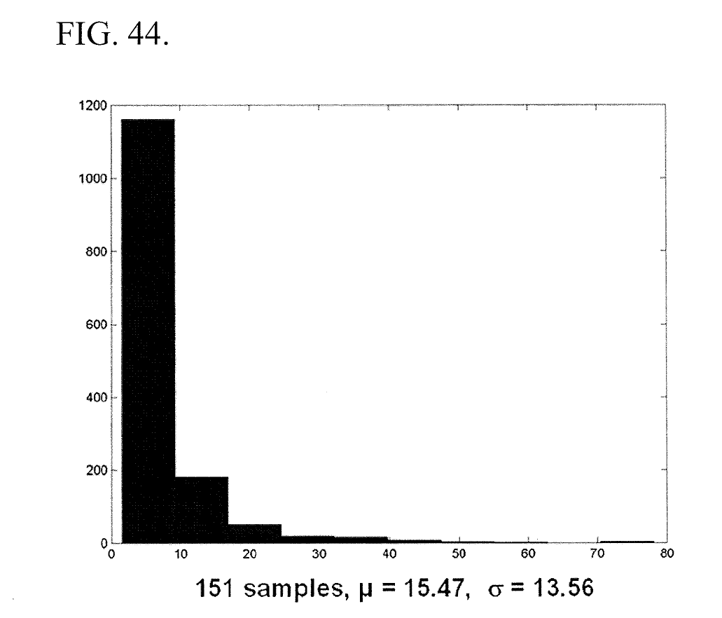

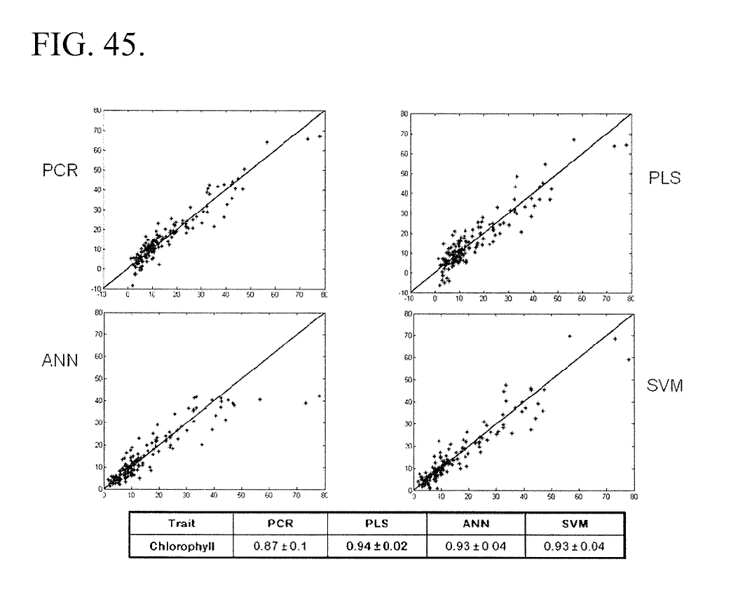

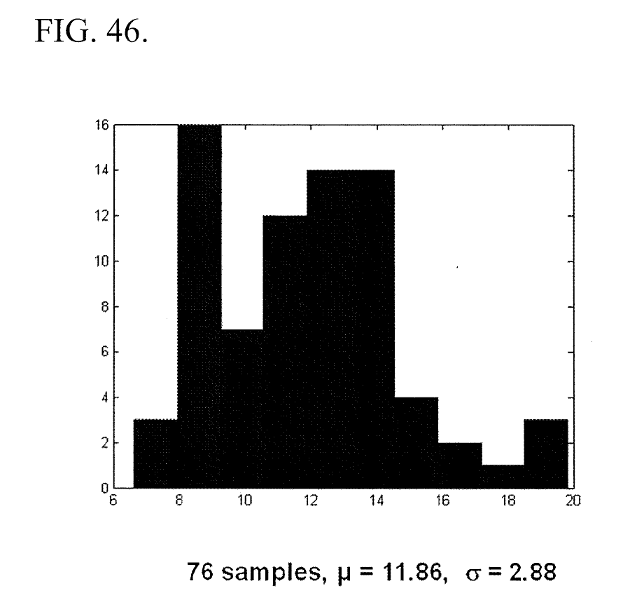

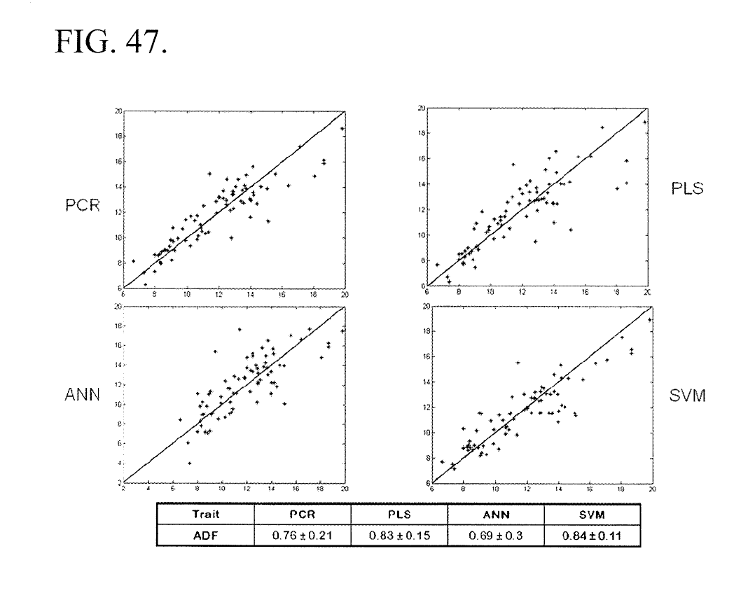

As an example, FIG. 4 shows such a comparison for the total saturated fatty acid content (Total Sats), obtained from analysis of total saturated fatty acid training data as shown in FIG. 3. FIG. 4 shows that the ANN algorithm outperformed the other three algorithms for this trait, and most closely modeled the actual value of the trait over all the training samples. A similar analysis was performed for 15 different seed compositional traits on the Unity machine, and it was found that different calibration models developed from the same training data were superior for analysis of different traits. FIGS. 3-47.

The data distribution for each of several particular traits of interest is tabulated in Table 1, and the comparison of R² values for each of these 11 traits is tabulated in Table 2. Machine learning models (ANN and SVM) outperformed traditional statistical approaches (PCR and PLS) 72% of the time ( 8/11), and therefore traditional statistics approaches outperformed machine learning models 27% of the time. If a researcher were to have examined only the C18:1, C18:2, C18:3, and C16:0 traits, for example, that researcher could reasonably conclude that the ANN model would be preferred at least across all seed compositional traits, which is obviously not the case.

TABLE 1
Data distribution for 15 compositional traits

| Trait | No. Training Samples | Mean | Std. Deviation |
|---|---|---|---|
| ADF | 76 | 11.86 | 2.88 |
| Chlorophyll | 151 | 15.47 | 13.56 |
| Glucosinolates | 402 | 12.31 | 6.57 |
| Moisture | 423 | 5.34 | 0.74 |
| Protein | 151 | 26.56 | 2.59 |
| Total Oil | 423 | 45.95 | 3.55 |
| Total Sats | 1442 | 6.93 | 0.63 |
| C18:1 | 1442 | 72.28 | 4.69 |
| C18:2 | 1442 | 15 | 2.99 |
| C18.3 | 1442 | 2.9 | 2.36 |
| C16:0 | 1442 | 3.8 | 0.36 |

TABLE 2
Comparison of R² values for 15 compositional traits

| Trait | PCR | PLS | ANN | SVM |
|---|---|---|---|---|
| ADF | 0.76 ± 0.21 | 0.83 ± 0.15 | 0.69 ± 0.3 | 0.84 ± 0.11 |
| Chlorophyll | 0.87 ± 0.1 | 0.94 ± 0.02 | 0.93 ± 0.04 | 0.93 ± 0.04 |
| Glucosinolates | 0.69 ± 0.11 | 0.77 ± 0.1 | 0.82 ± 0.08 | 0.62 ± 0.15 |
| Moisture | 0.94 ± 0.04 | 0.95 ± 0.03 | 0.96 ± 0.03 | 0.93 ± 0.03 |
| Protein | 0.90 ± 0.06 | 0.93 ± 0.03 | 0.89 ± 0.07 | 0.90 ± 0.04 |
| Total Oil | 0.97 ± 0.02 | 0.98 ± 0.01 | 0.96 ± 0.02 | 0.93 ± 0.03 |
| Total Sats | 0.80 ± 0.03 | 0.76 ± 0.04 | 0.91 ± 0.01 | 0.83 ± 0.04 |
| C18:1 | 0.94 ± 0.01 | 0.91 ± 0.02 | 0.96 ± 0.01 | 0.91 ± 0.02 |
| C18:2 | 0.82 ± 0.03 | 0.84 ± 0.03 | 0.93 ± 0.01 | 0.78 ± 0.06 |
| C18.3 | 0.92 ± 0.02 | 0.90 ± 0.03 | 0.97 ± 0.01 | 0.91 ± 0.03 |
| C16:0 | 0.71 ± 0.03 | 0.63 ± 0.05 | 0.85 ± 0.02 | 0.75 ± 0.04 |

Table 2 highlights the method with the highest R² value for each trait. In some cases, two or more methods had very similar R² values (e.g., PLS, ANN, and SVM methods behaved very similarly in the analysis of the Chlorophyll trait). The R² value for the Glucosinolate trait was the lowest compared to the other traits. This was likely attributable to the fact that the reference chemistry method for this trait has a large variability (±3) between multiple runs for the same sample, and the calibration model was developed on the average of these values.

Calibration models are built for seed compositional traits on the Unity machine according to the foregoing to develop models for sunflower.

### Outlier Detection

Based on literature review, three techniques of outlier detection (Mahalanobis distance, sample leverage, and graph theoretic measure (ODIN)) were identified and implemented in MATLAB®. A voting procedure was implemented that flags a sample as an outlier if two or more methodologies categorize it as one that was implemented.

Using this voting procedure, 18 out of 1696 samples were identified as outliers. Six of these 18 outliers were determined to have either insufficient seed, or dirt, in the sample, and thus were removed from the training set. Four of the 18 outliers were determined to possibly be YSC seeds, and thus were set aside for further investigation. Moreover, eight of the 18 outliers were determined to have different NIR spectra in the visible region, possibly from a high chlorophyll content, and thus were also set aside for further investigation.

### Web Interface

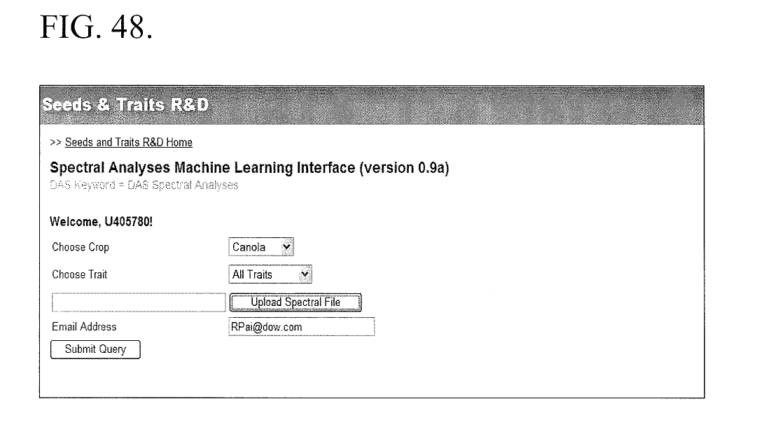

A web interface was designed in order to decouple the spectral data collection from the data analysis and thereby improve the throughput of the NIRS analysis. The web interface allows the user to easily upload spectral data and choose the crop and trait of interest. The interface submits the data and the values of the different options chosen to web servers that host the calibration models developed and maintained for each trait. A screen shot of the web interface is shown in FIG. 48.

What may be claimed is:

1. A method for determining a chemometric model of near infrared spectroscopic (NIRS) data to identify a characteristic of interest in a plant sample, the method comprising:
providing a plant sample to be analyzed;
acquiring NIRS data from the plant sample;
providing a computer readable storage medium comprising a database comprising a plurality of chemometric models of NIRS data, wherein the NIRS data comprises information regarding the characteristic of interest;
providing a computer comprising analytical programming for utilizing the plurality of chemometric models to determine a relationship between the NIRS data and the characteristic of interest;
selecting parameters for use in each of the plurality of chemometric models;
utilizing each of the plurality of chemometric models to determine a relationship between the NIRS data acquired from the plant sample and the characteristic of interest; and
determining the chemometric model that most closely relates the NIRS data acquired from the plant sample and the characteristic of interest, wherein the chemometric model that most closely relates the NIRS data acquired from the plant sample and the characteristic of interest identifies the characteristic of interest.

2. The method according to claim 1, wherein the method is automated.

3. The method according to claim 1, wherein the computer comprises analytical programming for identifying outlying data in the NIR data, and wherein the outlying data is removed from the NIR data before utilizing each of the plurality of chemometric models to determine a relationship between the NIR data and the plant trait of interest.

4. The method according to claim 1, wherein the computer comprises analytical programming for normalizing the NIR data to remove a contribution to the NIR data from the NIR spectrometer used to acquire the NIR data.

5. The method according to claim 1, the method further comprising a user interface wherein the plant from which the plant sample was obtained, and the plant trait of interest, is specified.

6. The method according to claim 1, the method further comprising transmitting an electronic message comprising the relationship between the NIR data and the plant trait of interest, as determined by the chemometric model that identifies the plant trait of interest.

7. The method according to claim 1, wherein the characteristic of interest is indicative of a plant trait of interest in the plant from which the plant sample was obtained.

8. A system for determining at least one characteristic(s) of interest in a plant sample obtained from a plant, the system comprising:
a near infrared (NIR) spectrometer; and
a processor containing a database comprising a plurality of chemometric models of NIR spectroscopy (NIRS) data from the plant sample, wherein the NIRS data comprises information regarding the characteristic(s) of interest, and also containing analytical programming for utilizing the plurality of chemometric models to determine a relationship between the NIRS data and the characteristic(s) of interest,
wherein the processor utilizes each of the plurality of chemometric models to determine a relationship between NIRS data and the characteristic(s) of interest, wherein the processor identifies the chemometric model that most closely relates the NIRS data and the characteristic(s) of interest, and wherein the processor utilizes the chemometric model that most closely relates the NIRS data and the plant trait of interest to determine the characteristic(s) of interest in the plant sample.

9. The system of claim 8, wherein the characteristic(s) of interest in the plant sample are indicative of a plant trait of interest in the plant from which the plant sample was obtained.

10. The system of claim 8, wherein the NIR spectrometer and the processor are not physically attached.

11. The system of claim 10, wherein the NIR spectrometer and the processor are separated by a distance of at least about 100 miles.

12. A method for determining a chemometric model of near infrared spectroscopic (NIRS) data to identify a characteristic of interest in a plant sample, the method comprising:
providing a plant sample to be analyzed;
acquiring NIRS data from the plant sample;
providing a computer readable storage medium comprising a database comprising a plurality of means for performing multivariate chemometric analysis of NIRS data, wherein the NIRS data comprises information regarding the characteristic of interest;
providing a computer comprising analytical programming for utilizing the plurality of means for performing multivariate chemometric analysis of NIRS data to determine a relationship between the NIRS data and the characteristic of interest;
selecting parameters for use in each of the plurality of chemometric models;
utilizing each of the plurality of means for performing multivariate chemometric analysis of NIRS data to determine a relationship between the NIRS data acquired from the plant sample and the characteristic of interest; and
determining the means for performing multivariate chemometric analysis of NIRS data that most closely relates the NIRS data acquired from the plant sample and the characteristic of interest, wherein the means for performing multivariate chemometric analysis of NIRS data that most closely relates the NIRS data acquired from the plant sample and the characteristic of interest comprises a chemometric model that identifies the characteristic of interest.

13. A method for determining a characteristic of interest in a plant material, the method comprising:
providing a sample of the plant material;
utilizing the system of claim 8 to determine the characteristic of interest in the sample; and
(a) if the sample is determined to comprise the characteristic of interest, then assigning the characteristic of interest to the plant material, or
(b) if the sample is determined not to comprise the characteristic of interest, then not assigning the characteristic of interest to the plant material,
thereby determining the characteristic of interest in the plant material.

14. A method for determining a trait of interest in a plant, the method comprising:
providing a sample obtained from the plant;
utilizing the system of claim 8 to determine a characteristic in the sample, wherein the characteristic is indicative of the trait of interest in the plant; and
(a) if the sample is determined to comprise the characteristic, then assigning the trait of interest to the plant, or
(b) if the sample is determined not to comprise the characteristic, then not assigning the trait of interest to the plant,
thereby determining the trait of interest in the plant.

15. The method according to claim 14, wherein the trait of interest is a seed compositional trait.

16. A method of introducing into a plant at least one desired trait, the method comprising:
providing a sample obtained from a first plant;
utilizing the system of claim 8 to determine the presence of a characteristic in the sample, wherein the characteristic is indicative of the trait of interest in the first plant, thereby determining the trait of interest in the first plant;
crossing the first plant with a second plant of the same species to produce F₁ progeny plants;
selecting one or more progeny plants that have the trait of interest to produce selected progeny plants;
backcrossing the selected progeny plants with the first plant to produce backcross progeny plants;
selecting for backcross progeny plants that have the trait of interest and physiological and morphological characteristics of the second plant to produce selected backcross progeny plants; and
repeating the backcrossing and selection steps three or more times, to produce inbred selected fourth or higher backcross progeny plants that comprise the trait of interest.

17. The method according to claim 16, wherein the system of claim 7 is utilized after a backcrossing step to determine the presence of the characteristic that is indicative of the trait of interest, in a sample obtained from the backcross progeny plant.

18. The method according to claim 17, wherein the system of claim 7 is utilized after every backcrossing step to determine the presence of the characteristic that is indicative of the trait of interest, in a sample obtained from the backcross progeny plant.

19. The method according to claim 16, wherein the trait of interest is a seed compositional trait.
